(19) United States
(12) Patent Application Publication
(10) Pub. No.: US 2004/0097195 A1
(43) Pub. Date: May 20, 2004

(54) Vehicle-to-vehicle visual messaging system and method

(76) Inventor: Mark N. Selleck, Jersey City, NJ (US)

Correspondence Address: Bierman, Muserlian and Lucas, 600 Third Avenue, New York, NY, 10016, US

(21) Appl. No.: 10/299,440

(22) Filed: Nov. 18, 2002

(51) Int. Cl. H04B 7/00

(52) U.S. Cl. 455/41.3; 455/73; 340/425.5

(57) ABSTRACT

The present invention discloses a two-way, reciprocal, instant visual messaging system comprising a portable electronic command terminal and at least one portable, external, electronic display in communication with the command terminal, the command terminal configured to enable the creation and sending of variable messages to the display(s), where the command terminal and display(s) do not require a shared network with other command terminals or their associated display(s).

### COPYRIGHT NOTICE AND PERMISSION

A portion of the disclosure of this patent document contains material that is subject to copyright protection. The copyright owner has no objection to the facsimile reproduction by anyone of the patent document or the patent disclosure, as it appears in the patent and Trademark Office patent files or records, but otherwise reserves all copyright rights whatsoever. The following notice shall apply to this document: Copyright © 2002 AutoChat, LTD.

### FIELD OF THE INVENTION

The present invention relates to a system and method for two-way, instant, live, spontaneous, context-driven, interactive, mutual, reciprocal, dynamic, programmable, variable, mobile, visual messaging.

### BACKGROUND OF THE INVENTION

Most people by nature desire to interact socially using language and symbols, units of meaning or “messages”. Simply put, most people by nature desire to “chat,” namely to send messages back and forth in real-time. This is clear from the explosive growth in popularity of “instant messaging” services on the Internet and via beepers and cellular telephones, by the increasing popular remote participation of individuals in games, as well as by the new and evolving instant chatting shorthand standard that has developed on a grass roots level that employs emoticons and other new ways, often abbreviated, of expressing ideas. For example, the emoticon message “;)” is commonly understood to represent a smile with a wink. As other examples, the messages “how r u”, “what r ur plans?” and “LOL” are new functional equivalents of “how are you”, “what are your plans?”, and “laughing out loud”.

It is also true in other situations. For example, people in vehicles frequently desire to chat with their friends or others in nearby vehicles. One or more passengers in one vehicle may wish to begin a conversation with friends or even strangers in vehicles parked across the street or stopped at a stoplight or in a traffic jam. A single man may wish to introduce himself to an attractive woman he sees in an adjacent vehicle, or invite her to a party, and the woman, in turn, may wish to engage the man in dialogue. Children or others may wish to play games back and forth with children in other vehicles. People stuck in traffic may wish to pass the time by engaging those nearby in friendly small talk. Children traveling cross-country with their parents may wish to entertain themselves by striking up conversations with passengers in other vehicles. Friends or family traveling in groups of vehicles may wish to exchange messages-regarding plans for the evening, their trips, their experiences, etc.

A multitude of other similar situations arise on a daily basis and in other environments, such as boating, drive-through restaurants, street vendors and chatting among vehicles and people on the street or between and among people at the park or at concerts, stadium games, other venues, etc.

As recent and new advances in technology make it possible for vehicles to navigate themselves to their desired destination, occupants of one vehicle will enjoy even more opportunity to communicate safely back and forth with occupants of others.

Verbal communication between vehicles is not a viable solution to enable instant chatting between vehicles. Noise and distance usually render chatting between vehicles difficult or impossible. As we all know, audible street noise includes engines roaring, horns honking, etc. Internal vehicle noise can also be a problem, with internal vehicle engine noise, radios and sound systems blaring, thus rendering cell phone conversations difficult or impossible. Sounds that could overcome noise and distance would be prohibitively loud. Cell phones do not produce loud noises in order to facilitate instant chatting, but while many people have cell phones today, calls can be dropped or a friend's phone number may not be remembered. A stranger's number is not even known, thus he or she cannot be called.

Indeed, all existing devices that facilitate instant chatting “on the go” and “on the fly,” such as cell phones, beepers, beeper-enabled cell phones, laptop computers or personal digital assistants (PDAs) are ill-suited to vehicle-to-vehicle chat for a variety of reasons. For example, all of the above-mentioned devices require both parties to be part of a pre-existing network, each party with a separate address that must be remembered or immediately available.

Participation in a pre-existing network such as a cellular network, satellite network, Intranet network, or the Internet network typically entails that each participant purchase a subscription to the network with a recurring monthly charge. Wireless Internet access is expensive and, at present, not widely available, especially on highways and in rural areas. Furthermore, like the cell phone number of the friend or stranger stopped next to one in traffic, all of the above-mentioned devices require that the specific address (or functional equivalent) of the intended interlocutor be known in advance or immediately available. This requirement is ill-suited to a vehicle occupant who wishes to chat with others, known or unknown, nearby, and who most often does not know the specific person with whom he or she will come into contact, let alone know his or her network address or functional equivalent.

Even walkie-talkies and CB radios, which do not operate on a network, as defined here, have many of the same disadvantages as cell phones. For example, both the sender and recipient must normally be tuned to the same known frequency channel; and some brands are not interoperable with other brands of equipment. Also, these devices suffer the same problems with background noise, static, interference, and signal drop-outs as do regular cell phones.

And even PDAs with infrared ports for communication between two parties with a device have problems in vehicles and at a distance. For example, infrared is not feasible over long distances, through tinted vehicle windshields, or through rain, snow, fog or road dust. Infrared also requires a strictly direct alignment of specific infrared port to specific infrared port. Some brands of PDAs are not interoperable with other brands. Furthermore, free expression is limited to that format and content type facilitated by the respective operating system of the PDA in question. Many PDAs, for example, only enable the infrared peer-to-peer communication of addresses.

Thus, a vision-based, non-networked system and method for instant messaging is one of the only effective ways to communicate between vehicles. Indeed, a need exists for occupants of vehicles to be enabled to chat with each other like never before, i.e., for an easy-to-use messaging system and method for sending instant, spontaneous and/or programmable visual messages through the air back and forth interactively between or among people in adjacent or nearby vehicles, and via a system and method catered to the specific circumstances which confront such individuals who desire to so chat.

Some vehicle and other mobile display and signaling devices have been discussed in the prior art. See, for example, the following U.S. Pat. Nos. 2,559,163; 3,678,457; 3,750,138; 3,787,808; 3,800,430; 4,191,939; 4,361,828; 4,431,984; 4,574,269; 4,631,516; 4,868,542; 4,928,084; 5,132,666; 5,500,638; 5,870,110; 5,905,434; 5,973,607; 6,154,126; 6,178,677; 6,195,000; and 6,300,870. In addition, some taxicabs in the larger cities today have electronic displays on the roof that display advertising messages.

Generally, however, these prior art devices are limited in many ways. They are limited to one-way, non-interactive, emergency, warning or vehicle diagnostics signaling; are intended for operation only by the driver; are limited to placement in the rear window for projecting messages backward; operate strictly by hardwire rather than by wireless means; are powered strictly by a physical connection to the vehicle's electrical system rather than wirelessly powered by batteries; are strictly designed for permanent placement in the vehicle; do not facilitate “instant send” of characters typed on the command terminal as they are typed to a designated display; are designed with one command terminal that operates only one display rather than one command terminal operating multiple displays; are only capable of displaying messages in non-mirrored fashion, not in a “mirrored” or reversed fashion that is capable of being read via a rearview or similar mirror; are coupled to the brake pedal; display only a limited number of pre-selected messages; or accommodate no pre-selected or programmable messages. Importantly, all of the known prior art devices are intended and designed only for the one-way display of one message to others, not for enabling an interactive, spontaneous, dynamic, mutually-reciprocal dialogue involving multiple messages in real-time between and among persons in different vehicles. All of the known prior art devices are intended and designed only for talking to, not chatting or communication with and among persons in different vehicles.

### SUMMARY OF THE INVENTION

To overcome the disadvantages of the prior art and the meet the needs of the present, the present invention comprises a system and method for two-way, instant, live, spontaneous, context-driven, interactive, mutual, reciprocal, dynamic, programmable, variable, mobile, visual messaging among people in different vehicles and elsewhere. The system and method of the invention enable a new variation on an age-old form of social interaction, namely, chatting. Vehicle occupants everywhere can now chat among themselves in a way never before facilitated by the systems and methods of the prior art. The system and method of the present invention enable all vehicle occupants, indeed, society itself in a multitude of circumstances, to chat in a manner like never before.

More particularly, in one embodiment, the invention discloses a two-way, reciprocal, instant visual messaging system comprising a mobile electronic command terminal and at least one mobile, external, electronic display in communication with the command terminal, the command terminal configured to enable the creation and sending of variable messages to the display(s), where the command terminal and display(s) do not require a shared network with other command terminals or their associated display(s) to communicate.

In another embodiment, the invention discloses a system for enabling live, instant, spontaneous, context-driven, interactive, mutual, reciprocal, dynamic, programmable, two-way, variable visual message communications among persons in different vehicles, comprising:

an electronic command terminal suitable for use by a person in a vehicle, the command terminal suitable for attachment to a vehicle, the command terminal configured to enable the creation, editing, storing and sending of variable messages, the command terminal further not requiring a shared network with other command terminals or their associated display(s) to communicate; and

at least one external electronic display in communication with the command terminal, the display(s) suitable for attachment to a vehicle and configured to receive messages sent via the command terminal and to display the messages to be visible by other potential visual messaging interlocutor(s).

### BRIEF DESCRIPTION OF THE DRAWINGS

These and other features and advantages of the invention will now be described with reference to the drawings of certain preferred embodiments, which are intended to illustrate and not to limit the invention, and in which like reference numbers represent corresponding parts throughout, and in which:

FIG. 1 is a top view of a command terminal of one embodiment of the invention;

FIG. 2 is a side view of the command terminal of FIG. 1;

FIG. 3 is a block diagram showing some components of one embodiment of the invention;

FIG. 4 is a perspective view of a display of one embodiment of the invention, showing layers in the construction;

FIG. 5 is a perspective view of an alternative embodiment of a display;

FIGS. 6-19 are a series of artistic renditions, some arranged in approximate time sequence, showing passengers in vehicles and others using an embodiment of the invention to display messages among people in different vehicles and elsewhere;

FIG. 20 is pictorial diagram showing a command terminal in wireless communication with six different displays simultaneously, each display showing a different message;

FIG. 21 is an alphanumeric display character set for one embodiment of the invention;

FIG. 22 is an electrical schematic diagram of the command terminal of one embodiment of the invention;

FIG. 23 is an electrical schematic diagram of a display of one embodiment of the invention;

FIG. 24 is an electrical schematic diagram of an LCD display module of one embodiment of the invention;

FIG. 25 is an electrical schematic diagram showing LED driver circuitry for use in the display of one embodiment of the invention;

FIG. 26 is an electrical schematic diagram of a buffer and transistor array for use in the display of one embodiment of the invention;

FIG. 27 is a chart showing keyboard hardware definitions used in FIG. 22;

FIGS. 28 and 29, taken together, set forth a flowchart representation of the primary operations carried out within the command terminal of FIG. 1, controlled primarily by the master microcontroller of FIG. 22;

FIG. 30 sets forth a flowchart representation of command terminal operations carried out primarily by the slave microcontroller of FIG. 22;

FIGS. 31-35, taken together, set forth a flowchart representation of the primary operations carried out with the display of FIG. 4, controlled primarily by the slave microcontroller of FIG. 23; and

FIG. 36 sets forth a flowchart representation of display operations carried out primarily by the slave microcontroller of FIG. 23.

### DETAILED DESCRIPTION OF THE INVENTION

The system and method of the present invention is intended for use primarily by passengers in one vehicle to communicate in two-way fashion with passengers in a different, nearby vehicle or elsewhere using instant visual text or other messages. The system and method of the present invention are designed as intuitive, easy-to-use, and specifically catered to the purposes and circumstances of enabling vehicle-to-vehicle and other mobile chat in a manner like never before. Fun, personal, context-driven, instant, real-time, dynamic, interactive, mutual, reciprocal chat sessions are now made possible with the invention. The invention allows spontaneous conversations to take place between and among two or more parties, perhaps strangers, in a multitude of circumstances, who desire to chat but have no prior knowledge of the exact place and time that have brought them into contact with each other.

More particularly, in one embodiment, the invention discloses a system and method that enables vehicle-to-vehicle chat including the following features:

3 methods of message sending: (a) “instant-type”, (b) prepare-and-send on the fly, and (c) prepare-store-and-send-instantly. That is, the present invention enables chatters to (a) see via the sender's display every character the sender creates as the sender creates it, as well as (b) enables chatters to fully prepare, edit and make coherent, grammatically correct, etc., messages—still in spontaneous, context-driven fashion—before displaying it by clicking “send”, similar to the method employed in certain currently popular online instant messaging systems, such as AOL and Yahoo. The present invention also (c) enables chatters to store commonly used or predetermined and previously-stored messages for one-click recall and display.

A lightweight, portable command terminal with an LCD display to facilitate creation, storing, editing, scrolling, and sending of messages.

Message creation editing keys (clear, backspace, left arrow, right arrow) (stored, sent, or unsent).

Global device command keys (clear, select all displays, mirror all messages, instant type).

A “mirror” toggle key that, when active, sends messages to their designated display(s) in a reverse-like fashion that can be read, for example, via a rear-view or other mirror.

A command terminal that controls up to 6 displays and contains a pad of toggle keys by means of which displays assigned to locations one through six are designated as either active or inactive with respect to sent messages, via any of the 3 previously stated methods

Interchangeable displays that may be specified as desired to function as display one through six relative to the keys on their command terminal display-select toggle keypad.

Up to 6 displays, each of which may display a different, the same or no message, in any combination, by means of their command terminal.

Up and down arrow pre-programmed message scroll keys that recall said messages to the command terminal LCD for viewing, editing, re-storing and/or send purposes.

A command terminal that contains both (a) a store key and (b) a pad of 10 “one-click” pre-programmable message keys for, respectively, (a) saving messages to addressed memory linked to a specific button on the command terminal and (b) instant display of a stored message to all display(s) designated as active. The store key also enables displays to be logically attached (and detached) to one of the 6 address locations as represented by the 6 separate keys on the display toggle key pad mentioned above via a key sequence on the command terminal.

A mobile display or group of displays, each suitable for mounting, detaching and remounting relative to the preference and/or purpose of the user.

A mobile command terminal in wireless communication with its display(s), and suitable for mounting, detaching and re-mounting relative to the preference and/or purpose of the user.

Battery charged display(s) suitable to be powered by hardwire means, including by plugging it/them into the vehicle's cigarette lighter or by connecting its power source to that of the host vehicle.

A battery charged command terminal suitable to be powered by hardwire means, including by plugging it into the vehicle's cigarette lighter or by connecting its power source to that of the host vehicle or some other source.

A cigarette lighter adapter and cable, suitable for daisy chaining multiple components of the device, for example, suitable for plugging in both a command terminal and a display for power purposes.

Message creation editing keys (clear, erase, right arrow, left arrow) all for use within any of the 3 previously mentioned methods of message sharing.

A full alphanumeric keyboard.

4 levels of interference protection to ensure (a) that messages only appear on display(s) linked to and sent by the master command terminal to which they are logically attached, and (b) that communication between a master command terminal and its logically attached display(s) occurs as intended by the user and without corruption or interference.

For safety reasons, the driver of a vehicle normally will not type on the keyboard while his or her vehicle is in motion. If, however, the vehicle is parked or stopped at a stoplight or in a traffic jam, the driver may safely use the full keyboard to communicate. Even if the vehicle is moving, however, the driver may safely use certain “one-click” buttons of the invention (described below), in a manner similar to clicking a preprogrammed button that selects a favorite radio station, that activates the instant display of pre-programmed messages to all selected display(s) without requiring the driver to take his or her eyes off the road to type on the keyboard.

In one embodiment, the invention includes at least one mobile display having an array of light-emitting diodes (LEDs) (or other means of sculpting light to visually convey a message) for mounting in or on a vehicle, and a separate, mobile command terminal in digital communication with the display, the command terminal having a full alphanumeric keyboard, programmable function and selector keys, one or more microprocessors and/or microcontrollers running proprietary software, display logic and memory. Some or all of the display logic and/or processing logic and/or processing functions may be contained in the display itself or distributed between the display and command terminal in any variation as is most technically efficient and desirable.

In an alternative embodiment, some or all of the display logic is contained within the display itself, instead of or in addition to being contained within the command terminal, or may be contained in a separate device or integrated with the vehicle itself.

In both of the above-mentioned embodiments, the command terminal is configured for use by people in the vehicle for instantly generating either pre-selected and pre-stored messages or creating, editing, storing, recalling new variable messages, and scrolling through pre-programmed instant messages and/or some combination thereof for display on the display(s) to communicate with people in a different vehicle. Either the command terminal or the display(s), or both, may operate wirelessly with respect to both power and intercommunication.

Other features and advantages of a preferred embodiment of the invention include, but are not limited to, the following:

Both the display and the command terminal are separately mobile, but either or both can also be set up in a given position as the preference and convenience of the user dictates, perhaps the command terminal with Velcro strips or a custom holster, and either or both may be installed or mounted in the vehicle at the time of manufacture or accommodated as a custom available feature, such as in a vehicle door, window, dashboard or back seat.

In a preferred embodiment, the display is a flat panel device with an alphanumeric array of light-emitting diodes (LEDs), with associated driver electronics contained within the display, suitable for mounting in a window of a vehicle, and suitable for displaying ASCII text characters. Non-ACSII graphics may also be displayed.

The display may be removably mounted on or next to a window. Suction cups are not required. Preferably, a bracket is used for mounting on the side window. The bracket slides behind the window glass without damaging the glass or the window frame, similar to a cup holder.

The invention includes a “mirror” feature to optionally display messages in “reversed” format so that messages may be viewed via the rear view mirror of the vehicle immediately in front of the displaying vehicle and read as normal script if the participants are communicating in that way. In this scenario, the displaying vehicle would most likely be sending the messages from a display projected and/or mounted in that vehicle's front window, with the vehicle in front responding with non-mirrored text from a display projected and/or mounted in that vehicle's rear window.

The invention can also be used to play games. Two individuals in two different cars, each equipped with the invention could use the sending of messages back and forth in order to win some pre-defined game, such as a linear version of Tic Tac Toe or non-time-sequential version of Paper, Rock Stone, or some combination. This game is defined purely mathematically given the field parameters of any possible play between two devices, with meaningful, playful values assigned, possibly with each player having the ability to use X's and O's from a pre-determined number, or some other pre-set possible values of play strategically to block the other player in the next move and/or be the first to create the winning series or pattern.

One possible game could be for the first person to display a letter. The second person would have to display that letter, and then another one that forms some beginning (until the end) of a legitimate word. Perhaps the first person to bring the word to the final character would be the winner, with a specific number of characters making or breaking the win. The game may be “the shortest word”. It could also be “the longest word”, both with whichever player who sums it up first being the winner, and each player trying to add an additional character that would block the other player from adding a character that would complete the word. Or the game could be word rather than character based so that the first individual displays a word to begin a sentence, and the second person displays that word and the next one, and the first person displays the first two words and a third one, and so on until a coherent sentence is reached. The object of the game may be to create the most creative grammatically coherent sentence or story where each person takes turns adding the next word. In an alternative, a first player would display a sentence or phrase with missing characters and the second player would have a number of guesses to figure out the secret sentence or phrase.

Because the device, if not mounted or installed, is mobile and can be removed completely from the vehicle at any time, children or others may wish to use it to play in their homes, back and forth from the window of one home to the window of another, back and forth from one side of the stadium to another, back and forth between and among two or more users of the device in a park or at a concert, and many other similar situations. In a preferred embodiment, the command terminal, the display, or both, may also be equipped with regular AC adapter plugs to receive power from any standard AC electrical outlet.

For example, a NYC sidewalk vendor who sells hot dogs to the cars stuck in one block of traffic for a typical 20 minutes on their way into the Holland Tunnel to New Jersey could use the present invention to communicate more efficiently with the vehicles in visible proximity who wish to make a purchase. The specific order as well as its price are examples of messages they might send to one another while communicating via the device. Drive-through windows at restaurants, for example, may find it more efficient to process orders using the device, etc.

The keyboard on the command terminal is a full alphanumeric keyboard that may be used in any language. The keyboard may also include emoticon or similar characters. The command terminal also includes several programmable function keys that employ a multiple number of codes as well as hold messages entered into the command terminal for retrieval.

Up to six different individually-addressable displays may be employed with one associated command terminal, so as to permit each window of a four-door vehicle to accommodate a display, front and rear windows included. Alternatively, more than one command terminal may be used in the same vehicle simultaneously by different passengers, each passenger creating and displaying different messages on different displays without concern of problems resulting from interference.

By means of the command terminal, the user can create, store, recall, edit, scroll and send messages to a specifiable display address recallable by a code, “one-click” button or key sequence. A different message may be displayed on each display. All displays may display messages simultaneously. The messages may either be the same, different, or empty, in any combination. Each message stays displayed persistently unless and until changed or cleared or until the display is powered off.

Individual characters of a message may be displayed on a selected display(s) immediately as their corresponding character key is struck on the keyboard of the command terminal and this occurs when the “instant send” key is toggled or programmed on, or character(s) may be stored in memory for display later when the “instant send” key is toggled off. In the present invention, message characters are “stored” in two different ways. First, characters may be stored “live” on the LCD screen of the command terminal, waiting for the “send” key to be struck before the characters are sent to the display. In normal operation, the time delay between the typing in of the characters on the LCD screen and the presentation of the characters to the display is typically on the order of a few seconds to a few minutes, although there is no actual limit. (The user will normally hit “send” shortly after he or she is comfortable with the message draft that has been composed.) The type of memory for this mode of storage is preferably a cache memory, and may be either non-volatile or volatile.

In the second storage mode, characters may also be typed in and stored for later retrieval using a “one click” key (discussed below). Typically, this type of storage will be for a much longer time frame, perhaps on the order of hours, days or even for the lifetime of the system. Since the one-click messages need to remain stored even after the system has been powered off, permanent, non-volatile memory is preferred for this mode of storage. The system may be equipped with some pre-programmed messages stored to the “one-click” keys at the time of manufacture. These messages can be changed just like messages stored by the user.

Several “one-click” buttons are numbered and provided on the command terminal on their own separate keypad. Each button may be configured to send a different pre-determined message to a selected display(s). Each button may be reprogrammed to send a different or no message. Sending an empty message is the functional equivalent of sending a clear command.

Message characters appear in either persistent or scrolling fashion on the display depending on the length of the message. In a preferred embodiment, each display can display up to 12 characters persistently, but a different size display may be chosen, if desired. If a message is sent that is more than 12 characters, then the display will begin to scroll on the 13^{th} character. If a message is sent that is 12 characters or less, it will display persistently on the display until cleared, until it receives a different message to display, or until the display is powered off. If a message is sent that is 13 characters or more, the message will scroll through the message persistently, again and again on the display until cleared, until it receives a different message to display, or until the display is powered off.

In a preferred embodiment, both the command terminal and the display(s) are designed to be mobile, for ease of use. They can be set up in a certain manner desired by one user, and then moved again to meet different needs of another user or different purposes of the same user. The command terminal can also be held in free form by an occupant of a vehicle, on his or her lap, for example, for typing messages for immediate display. A passenger in a vehicle may find this the generally preferred way to use the command terminal, passing the command terminal at the user's option to other passengers in different positions in the vehicle for them to use at different moments. The command terminal also has non-skid grips on its bottom surface to prevent unintended movement when the command terminal is resting on a seat, dashboard or shelf of the vehicle.

An occupant of a vehicle may set up the command terminal in a fixed position relative to his or her location in order to most conveniently use the system.

In addition, the display(s) can be set up in a fixed position—for example, in the left rear passenger side window—in order for the user to communicate with someone to his or her left in accord with the present intent of the user. It may later be moved to another location, such as the right front window, or the rear or another side window in order to meet a different purpose or for a different user. The display can also be held by hand to permit a user of the system to manually point the display where he or she wishes to engage different audiences in a more spontaneous, context-driven manner.

A user of the system may move the display, for example, from the side window to the rear window as circumstances dictate instantly to change the intended audience for or projection of the message; or the user may send a different message to another display already mounted or held in place to display messages in the intended direction. The display may also be customized to fit windows of specific models of vehicles, and may be integrated in some appropriate fashion, as could the command terminal, into the vehicle either at the time of vehicle manufacture, or post-manufacture.

In a preferred embodiment, both the command terminal and the display(s) are battery-powered, but they may be configured to operate from the DC power supply of the vehicle, such as from the cigarette lighter, car battery, or from an auxiliary source such as an external battery pack or solar panel. A DC-to-AC inverter is not required. In addition, both the command terminal and the display(s), and their components, are constructed of materials suitable for withstanding both high and low ambient temperatures, to permit both units to be left inside a vehicle for prolonged periods in either hot or cold weather. Of course, the units may be completely removed from the vehicle at any time.

The command terminal also includes input ports for connection, for example, to an external laptop computer, personal digital assistant or external ASCII keyboard. The operating system software by means of which the device is enabled includes routines to check these inputs to expand or change the manner of its operation, including, for example, to integrate voice recognition capabilities. Voice recognition capabilities may also be integrated into the operating system itself.

The command terminal and display(s) are also adaptable for use with voice recognition capability.

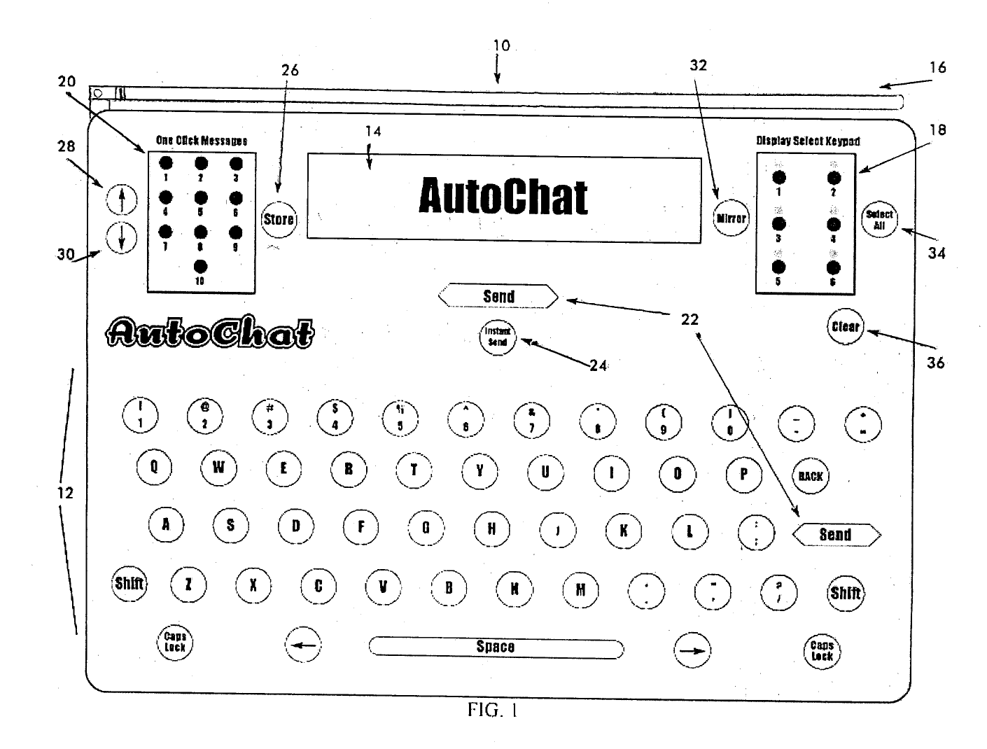

Turning now to the drawings, FIG. 1 is a top view of a preferred embodiment of the command terminal 10 of the invention. The command terminal 10 is preferably a thin flat plastic box or case equipped with a full alphanumeric keyboard 12. The command terminal preferably is smaller and lighter than a conventional laptop computer, and light enough to be held in one hand.

The keyboard is electrically coupled to a screen 14 (preferably an LCD screen), an antenna 16, a numeric keypad 20, a display select keypad 18, two “send” keys 22, an “instant send” key 24, a “store” key 26, a scroll up key 28, a scroll down key 30, a “select all displays” key 34, a “clear” key 36, a “mirror” key 32, and one or more microprocessors or microcontrollers, memory devices, radio transmitter, radio receiver and other electronic components (not shown in FIG. 1).

In a preferred embodiment, the keys of the keyboard 12 are membrane keys with a water-resistant surface. The antenna 16 preferably is a rubberized or other flexible antenna that folds down against the case of the command terminal. An internal battery holster (not shown) is included to hold one or more batteries to supply electric power.

Some of the message control keys, such as the “instant send” key 24, the “mirror key” 32, and each key in the display select keypad 18, have an associated LED or other light next to the key that is illuminated when that key has been selected or toggled or programmed on.

The clear key 36 of command terminal 10 serves several functions. Strike the “clear” key once, and the LCD display 14 on the command terminal is cleared of all text or other message data, if any, along with any displays currently toggled or programmed as “active” if “instant send” is also toggled as active. Displays are cleared by sending an empty message or employing some functional equivalent.

In an alternative embodiment, strike the “clear” key twice in a row, and it is the equivalent of pressing the “clear” key once and striking the “send” key 22. This is the functional equivalent of pressing the “clear” key once with “instant send” toggled on—all displays currently toggled as active have their displayed messages, if any, cleared. All the display(s) that are selected, if any, are sent an empty or blank message that clears the display(s) of any messages that may be on them. Strike the “clear” key three times in a row, and it is the equivalent of pressing the “clear” key once, pressing the “select all displays” button 34 and striking “send”. That is, pressing the “clear” key three times in a row is a quick and easy way to clear everything on both the command terminal LCD display and all six displays.

In a feature of one embodiment of the invention, each display has a serial number that is pre-recorded in a memory inside the display as well as on its outside case. The user attaches a specific serialized display to a specific desired external display (1-6) on a specific command terminal via a key sequence. To program a new serial number, all displays have to be toggled off. The user enters the specific serial number of a display on the LCD, then strikes shift, then store, and then selects the specific display-select toggle key to which he or she wishes to assign that specific display. The instant send toggle key will blink as confirmation that the serial number has been stored. The LCD will then clear. That serial number will now be stored on the NVRAM, and the command terminal will remember that the said specific display, represented by its serial number, is the logical equivalent of the location address to which it has been attached or signed. If the user strikes shift, then store, and then does not follow the sequence described above in this paragraph but types another character, software control routines controlling the command terminal break the subroutine and return to normal operational status. This serial number, once entered, is recorded in the command terminal to non-volatile memory, and will be maintained until erased or changed.

From the perspective of the command terminal, each location, for example, location 1, will hold the serial number from only one display. At the same time, one serial number from one display may be attached as any or all of the six locations. One erases a specific serialized display from being attached to a specific command terminal location (1-6) by overwriting the location with a blank serial number. If one has attached a specific serialized display to the command terminal in a specific location, and then adds the same serial number to another location in the same command terminal, unless the user erases the first location, the display will receive messages designated for both addresses from the command terminal. The location (1-6) to which a display is stored on the command terminal directly relates to specifically one of the 6 display toggle keys on the display toggle keypad 18 on the command terminal.

In a preferred embodiment, the LCD display screen 14 on the command terminal 10 (hereafter referred to as the “LCD”) can display up to 24 characters (two rows of 12) at once. A different size screen may be used instead, if desired. The LCD can hold a message of up to 24 characters. Messages longer than 24 characters must be divided into messages of 24 characters or less each. When a message of 12 characters or less is sent to a display(s), it/they will display each character persistently until an empty message is sent (by means of clearing the LCD and hitting “send” or by selecting the display and striking a “one-click key” that has no message (the equivalent of an empty message)).

In alternative embodiment, when a message of 12 characters or less is sent to a display(s), it/they will display each character persistently until an empty message is sent (by means of clearing the LCD and hitting “send” or by selecting the display and striking the “clear” key twice or by striking the “clear” key three times in a row or by selecting the display and striking a “one-click key” that has no message [the equivalent of an empty message]).

In another feature of the invention, a preferred embodiment has four levels of design to prevent radio or other interference, such as from the use of one device within transmission range of another. First, in a preferred embodiment, each command terminal has a transmission range of approximately only 40 feet.

Second, at the time of manufacture, batches of the command terminal are configured to operate on 10 different frequencies made freely available for such devices by the U.S. Federal Communications Commission.

Third, each display is configured only to display messages from the command terminal to which it has been attached or “assigned.” In one embodiment, each display is equipped with two microcontrollers, one of which constantly runs a subroutine that verifies the authenticity and integrity of each message as from its designated command terminal and as what its command terminal has sent. Each display has a unique serial number marked on its case and its internal circuitry. To assign a display to a specific command terminal, a user types a key sequence on the command terminal. Each display has a position indicator nob or key that the user can set to any number from one to six to serve as a quick access reminder of which display has been programmed to which address relative to the display select toggle switches 18 on the command terminal. When the user assigns the serial number of a specific display to a specific location on a specific command terminal, the display in question will then be able to receive messages from the particular command terminal and from it exclusively. In a preferred embodiment, the command terminal sends out the serial numbers of all attached or associated displays prior to sending each message, to enable each display to determine if a message is possibly intended for its specific display.

Fourth, in another feature of the invention, the command terminal of a preferred embodiment is also equipped with a receiver to determine if its transmission frequency is clear for unimpeded, uncorrupted transmission of messages. The command terminal is programmed to wait until the frequency it is using is clear before it sends any messages in order to prevent interference between its communication with its attached displays and the transmission of messages from another command terminal to its attached displays (which may be on the same frequency and within the same effective range) as well as to prevent any other type of interference that would garble or prevent a message being fully and accurately communicated from a specific command terminal to one of its attached displays. In a preferred embodiment, the amount of time it takes for actual transmission of a typical message from a command terminal to its display(s) is on the order of between one to four tenths of a second.

In normal operation, the system is operated as follows: First of all, the user positions the command terminal on his or her lap or in some other convenient and comfortable position; powers on the command terminal and display(s); and positions the display(s) in one or more vehicle windows.

Next, typing on the keyboard 12 causes characters to be instantly displayed on the LCD 14. In a preferred embodiment, the LCD may display up to two rows of 12 characters (up to 24) at a time. However, messages may be longer than 12 characters long. Each individual message may be up to 24 characters long. Characters on the LCD are visible in either bright or soft light, and the LCD may be equipped with a backlight for night operation, which may be turned on by striking store/shift/send and toggled off by striking store/shift/send again, and in such a repetitive cycle. The LCD screen is inset slightly into the command terminal case to minimize glare that might otherwise hinder visibility. Alternatively, a glare shield may be attached around the LCD screen.

Messages can be generated for display in several ways. First, the user selects the specific display(s) the user desires to use for a particular message by toggling on a display-specific toggle key (1 through 6) on the command terminal. In FIG. 1, these toggle keys are mounted on keypad 18. Each button toggles on or off when pressed. A “select all” key 34 on the command terminal, if struck, immediately toggles all displays on. To deselect all displays, the user hits button 34 twice. Each of the six (6) display toggle keys on the command terminal has an LED indicator light that lights up when it is toggled on. More than one display may be selected, up to a maximum of six displays. A display is selected by pressing an appropriate button on the selector pad 18.

If the user wishes to display each character of a typed message instantly in real-time on all active display(s) while the user is typing, the user presses the “instant send” button 24, which toggles on and off. With “instant send” toggled in the “on” position, the user is effectively “typing” directly on the display(s) itself in real-time as well as on the LCD.

When “instant send” is toggled to the “off” position, as the user types a message, it only appears and remains on the LCD screen. The message may be edited if desired using the “left arrow”, “right arrow” and “backspace” keys and by retyping, or the message may be cleared entirely from the LCD by pressing the “clear” button 36 once. Messages may also be edited in similar manner when “instant send” is toggled on, with the edits appearing on the LCD and selected display(s) simultaneously. The LCD may have a cursor to define the context of using editing functions. When the user is ready to display a message when “instant send” is toggled off, the user presses one of the two “send” keys 22, and the message is then instantly transmitted to the selected display(s) preferably by wireless means (such as RF signal), or by other means such as infrared or ordinary wired connection. When the user is ready to clear the message from the selected display, the user strikes the “clear” key 36 or sends a blank or empty message.

In an alternative embodiment, when the user is ready to clear the message from the selected display, the user presses the “clear” button 36 twice, or sends a blank or empty message.

Any message may be saved into an internal memory (not shown) in the command terminal by pressing the “store” button 26. In a preferred embodiment, up to 10 complete messages may be stored, although more could be stored with more memory. Thus, the command terminal is fully programmable, in one sense that multiple, complete messages may be stored, any of which may later be recalled or changed, if desired. Stored messages may be recalled for display by striking a single key on numeric keypad 20, the group of “one-click” keys. The user may also scroll forward and backward (by means of the LCD or by means of a display(s) if the “instant send” key is toggled on and the respective display(s) are toggled on via the display selector keypad) through all the stored messages using the “scroll up” and “scroll down” buttons 28 and 30 (FIG. 1). Stored messages may be erased by re-saving new or empty messages on top of the old ones.

Preferably, the system of the invention is pre-programmed at the time of manufacture with a number of messages such as “Would u like to chat?” In this embodiment, the 10 keys in the numeric keypad are also equipped to function as “one-click” messaging buttons, whereby pressing any button one time instantly sends a predetermined message (such “I'm Joe. What's ur name?” or another desired message) to a selected display(s).

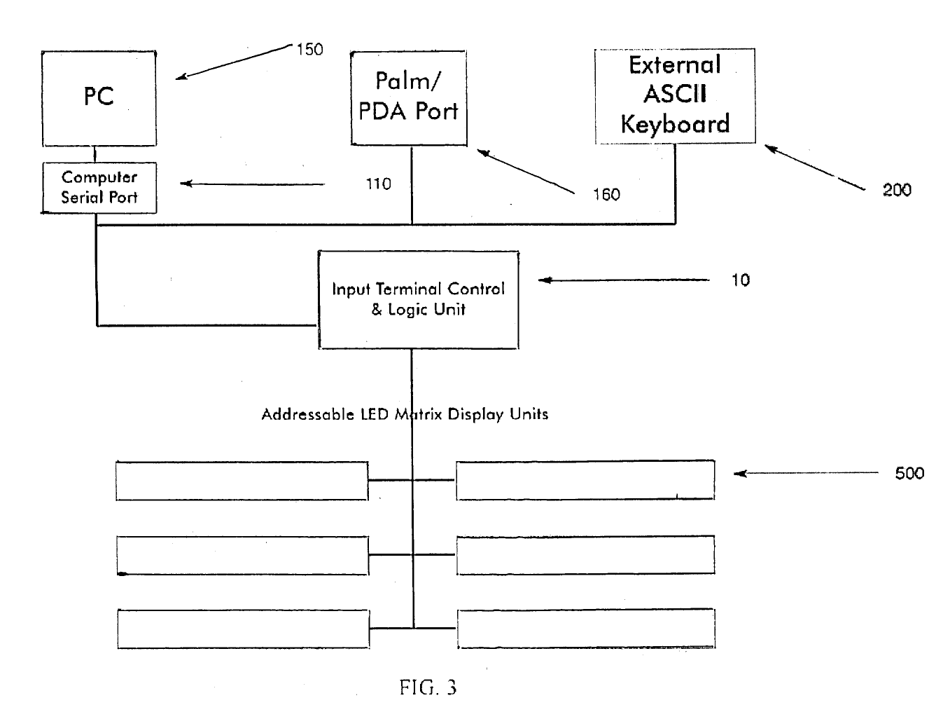

Preferably, voice recognition capabilities are also accommodated by the invention to allow the user to dictate rather than type messages for display. Voice input is captured either from a built-in microphone (not shown) or an external headset microphone or other means. Voice may be translated into text and input into the command terminal via an external laptop computer running voice recognition software, such as Dragon NaturallySpeaking® or IBM ViaVoice®, the laptop plugged into the serial port 100 of the command terminal (FIG. 3) or strictly by the operating system of the device itself.

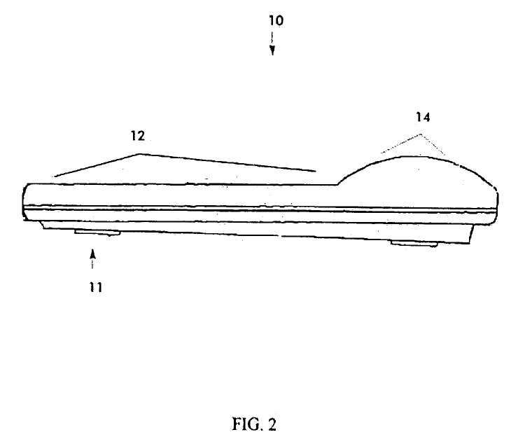

Turning next to FIG. 2, this figure is a side view of the command terminal 10 of FIG. 1. The keyboard is preferably located in the area 12 and the local LCD screen is preferably located in the area 14. Rubberized feet 11 are located on the bottom to stabilize the terminal.

Turning next to FIG. 3, this figure is a block diagram showing some major components of one embodiment of the invention. As previously discussed, command terminal 10 may be used to control up to six different individually-addressable displays 500. Command terminal 10 may be hard-wired to the displays, or may communicate wirelessly by RF signal, infrared signal or other means. Command terminal 10 includes an optional serial port 110 for connection to an external personal computer (PC) or other serial port compatible device 150; an optional Palm/PDA port 160 for connection to an external personal digital assistant; and an optional port for connection to an external ASCII keyboard 200.

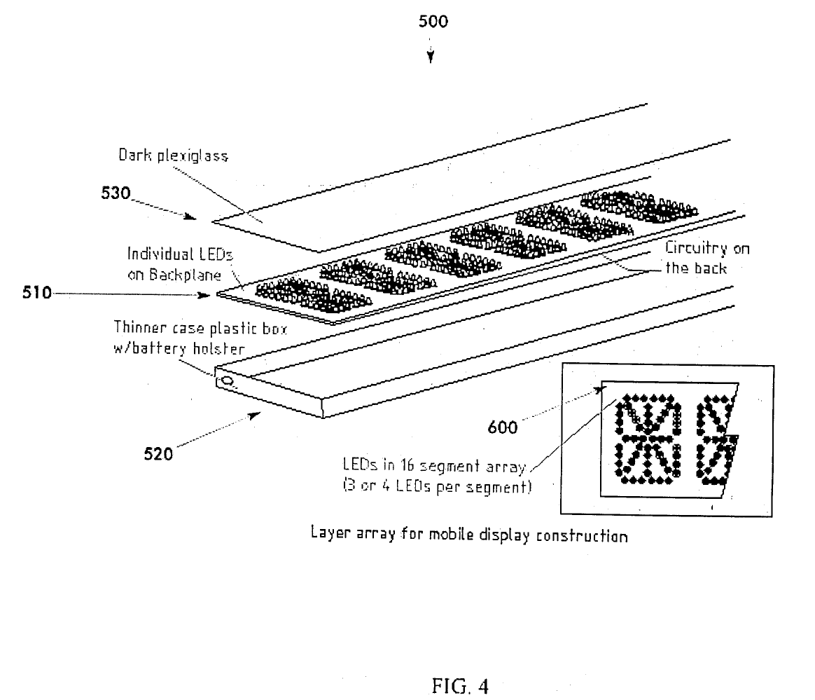

FIG. 4 is a perspective view of one of the displays 500 of the invention, showing the layers in the construction. Case 520 preferably consists of a thin plastic box containing a battery holster (not shown) for one or more batteries to power the display. In a preferred embodiment, backplane 510 is a flat surface on which are mounted up to twelve groups of LEDs or other light sources in a matrix array 600. A different number of LEDs may be used, if desired. LED driver circuitry (not shown) is mounted on the back of the backplane. An optional dark Plexiglas panel 530 may be mounted over the LED matrix array to provide a protective cover and to increase visibility in bright sunlight. In an alternative, the Plexiglas may not be necessary if the LED segments (not shown) are molded with a light dispersion lens.

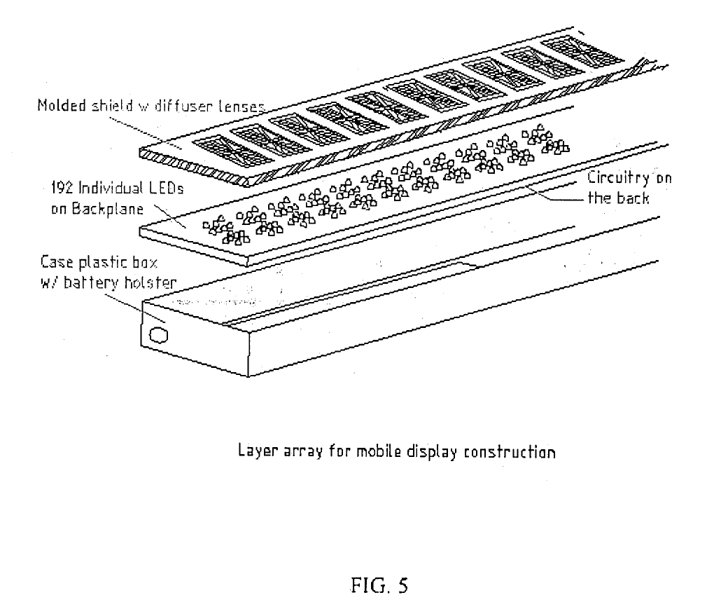

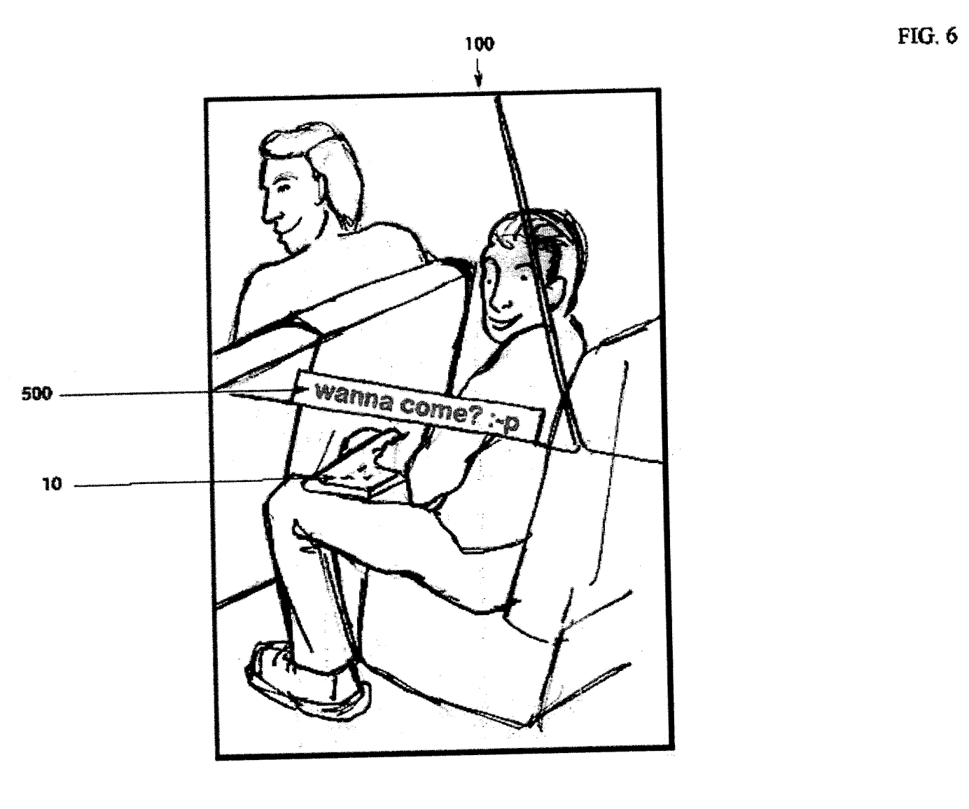

FIG. 5 is a perspective view of an alternative embodiment of a display.

Looking next at FIGS. 6-20, there are shown a series of artistic renditions, arranged in approximate time sequence, showing passengers in vehicles using the invention to display messages between and among vehicles, and more precisely, between and among individuals each communicating back and forth with the invention. For example, FIG. 6 shows a drawing of a passenger in a vehicle using one embodiment of the invention to display a message through a side window 100 of a vehicle. In this rendition, a male passenger in the left rear seat of a vehicle is shown typing the message “wanna come?:-p” on the keyboard of a command terminal 10 being held in the passenger's lap. The message is immediately displayed on a separate display 500 that is mounted in the left rear window 100 of the vehicle. In this embodiment, the command terminal is in wireless communication with the display, and the message has been transmitted by radio signal. Alternatively, a wired, infrared or other wireless communication link may be provided.

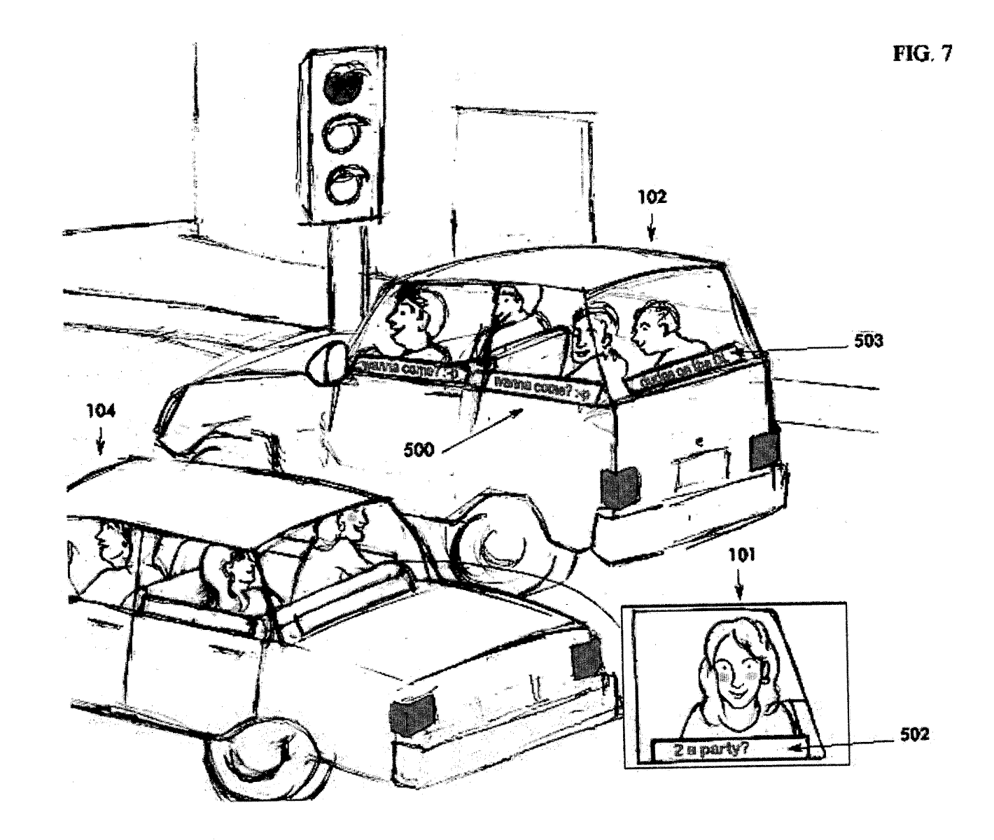

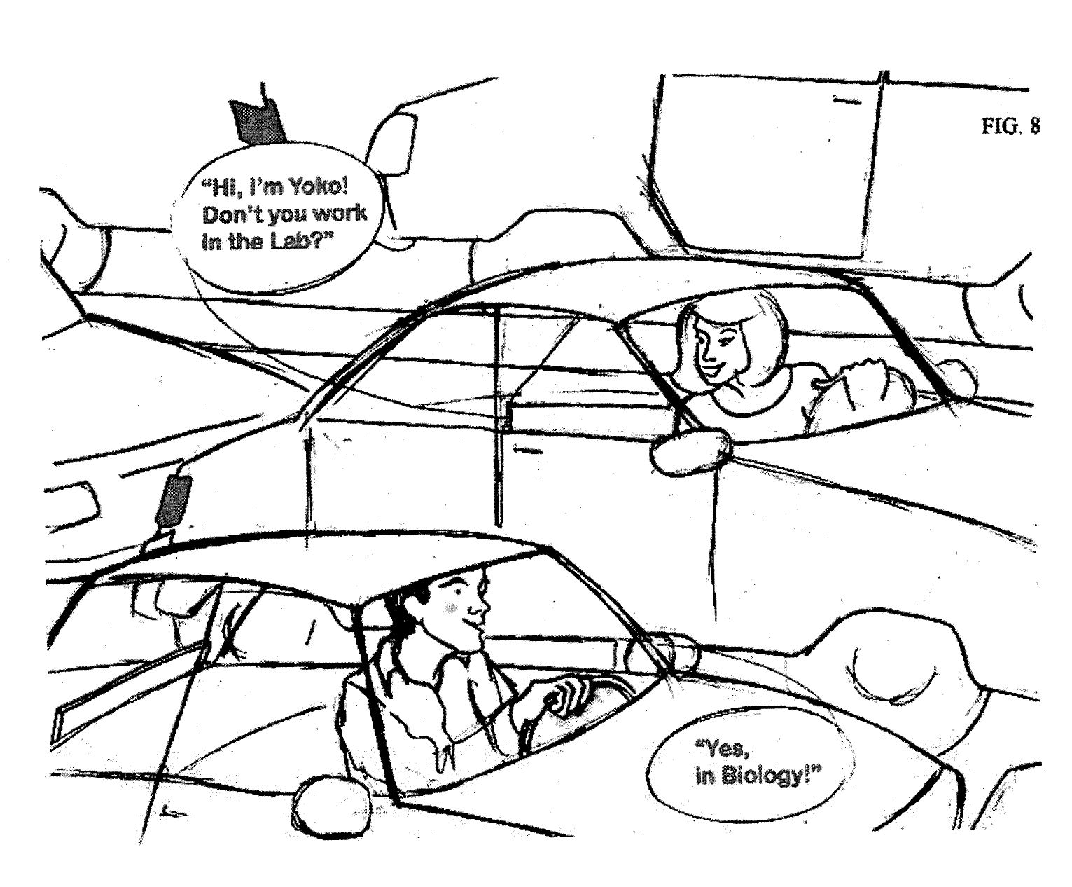

FIG. 7 is a broader view of FIG. 6. It shows the vehicle of FIG. 6 (far vehicle 102) stopped at a stoplight. The male passenger in the left rear seat of vehicle 102 has sent the message “wanna come?:-p” mentioned in FIG. 6. In a preferred embodiment, this message remains persistently displayed on display 500.

It should be noted that multiple displays are shown mounted in the windows of vehicle 102 in FIG. 7, in this case three—one in the left rear window, one in the left front window, and one in the back window 503. In this case, two of the three displays show the same message, but the display in the back window 503 shows a different message. Preferably, the displays are mounted along the bottom inside edge of each window in a manner designed to project visual messages outwardly, away from the vehicle and toward other vehicles or toward others on the sidewalk or elsewhere who may wish to engage in chat. Each display is light and portable enough to be held with one hand, and moved around at will either inside or outside the vehicle.

FIG. 7 also shows another vehicle 104 stopped alongside vehicle 102. A female passenger 101 in the right rear seat of vehicle 104 has responded to the male passenger's message by typing the message “2 a party?” on a command terminal (not shown) held in her lap, which message is shown in the inset as being displayed on a display 502 mounted in the right rear window of vehicle 104.

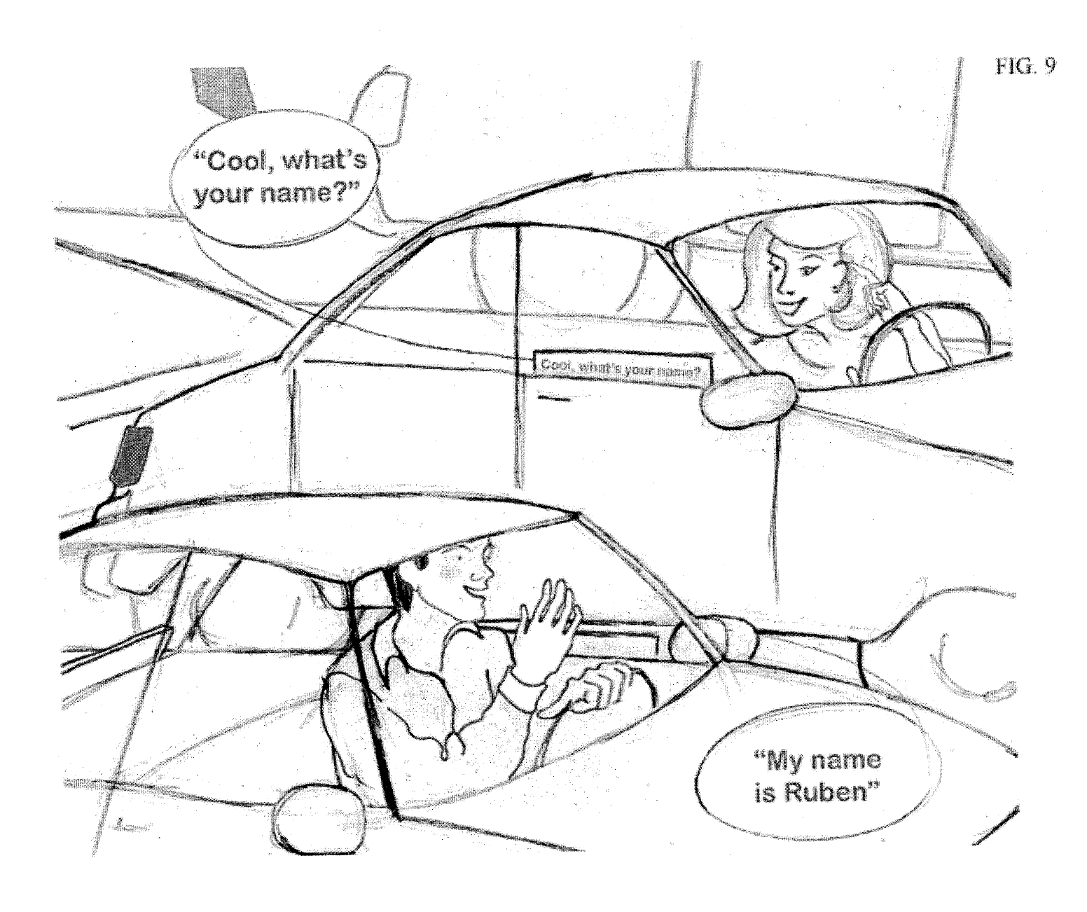

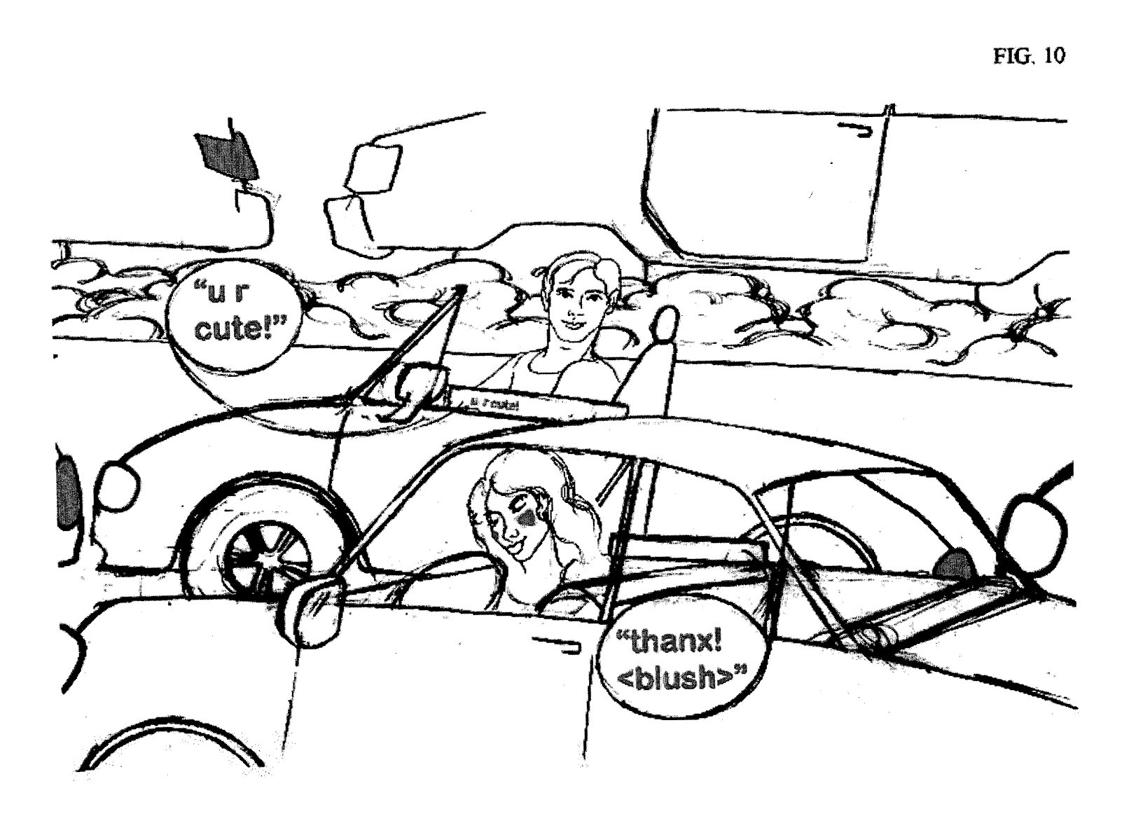

FIGS. 8 and 9 show a time sequence of two artistic renditions of people in adjacent vehicles stopped in heavy traffic. The people have decided to engage in a friendly, spontaneous visual chat session with each other using the invention while waiting for traffic to clear. In FIG. 8, the woman has recognized the man in the nearby car and has displayed the message “Hi, I'm Yoko. Don't you work in the Lab?” The man has responded “Yes, in Biology.” In FIG. 9, the woman has responded “Cool, what's your name?” and the man has responded “My name is Ruben.”

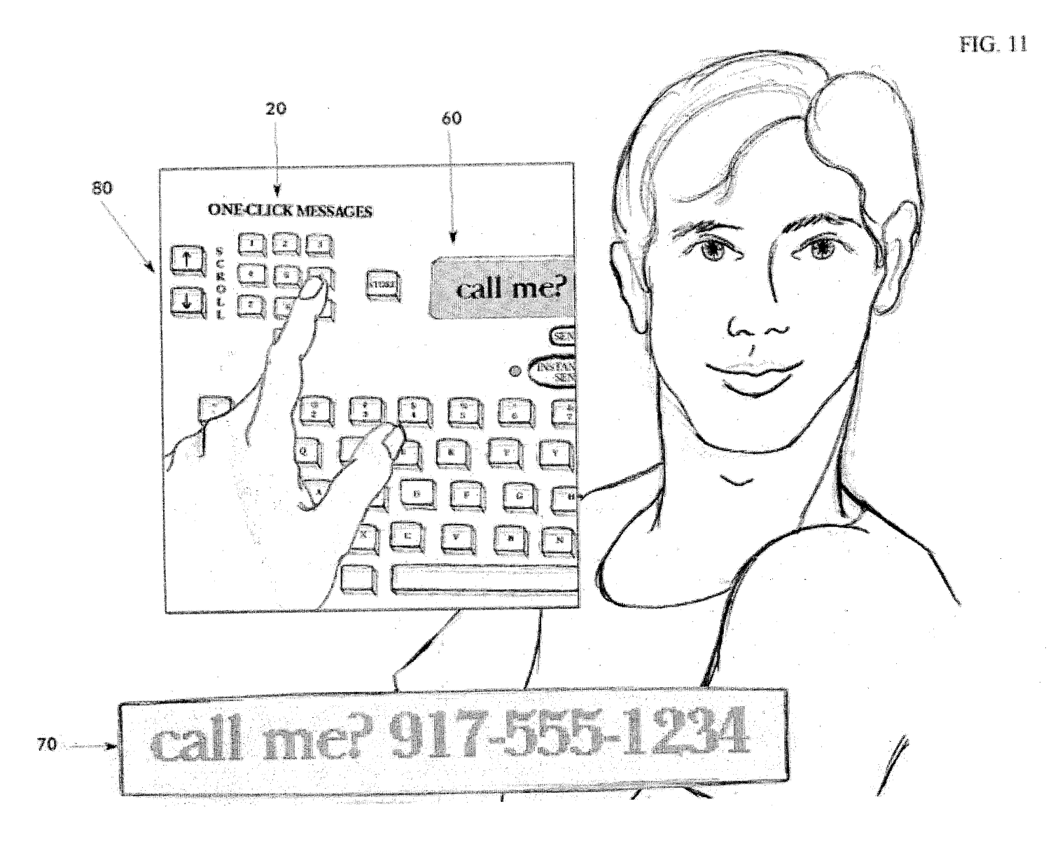

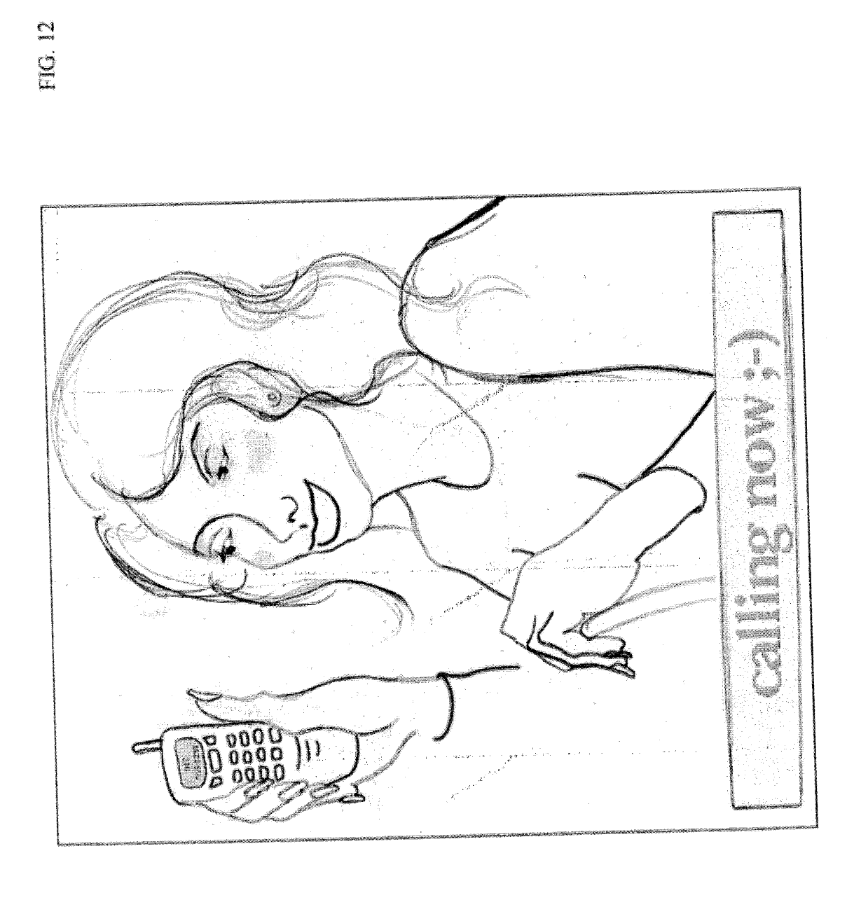

FIGS. 10-12 show a time sequence illustrating the use of the “one click” message feature of the invention. FIG. 10 shows a male messaging the female to his left that “u r cute!”. The female, in return, messages back “thanx!<blush>”. FIG. 11 shows the same male and female passengers. The male passenger is pressing one of the “one-click” buttons in the keypad 20 on the command terminal of the invention to display a pre-programmed message 70 containing his cell phone number. By pressing the “one-click” button, the pre-programmed message is also displayed on the command terminal LCD 60. By means of striking the up and down scroll arrows 80, the user could scroll through all the messages programmed into his command terminal. In FIG. 12, the female passenger is shown responding with another one-click message “calling now ;-)”.

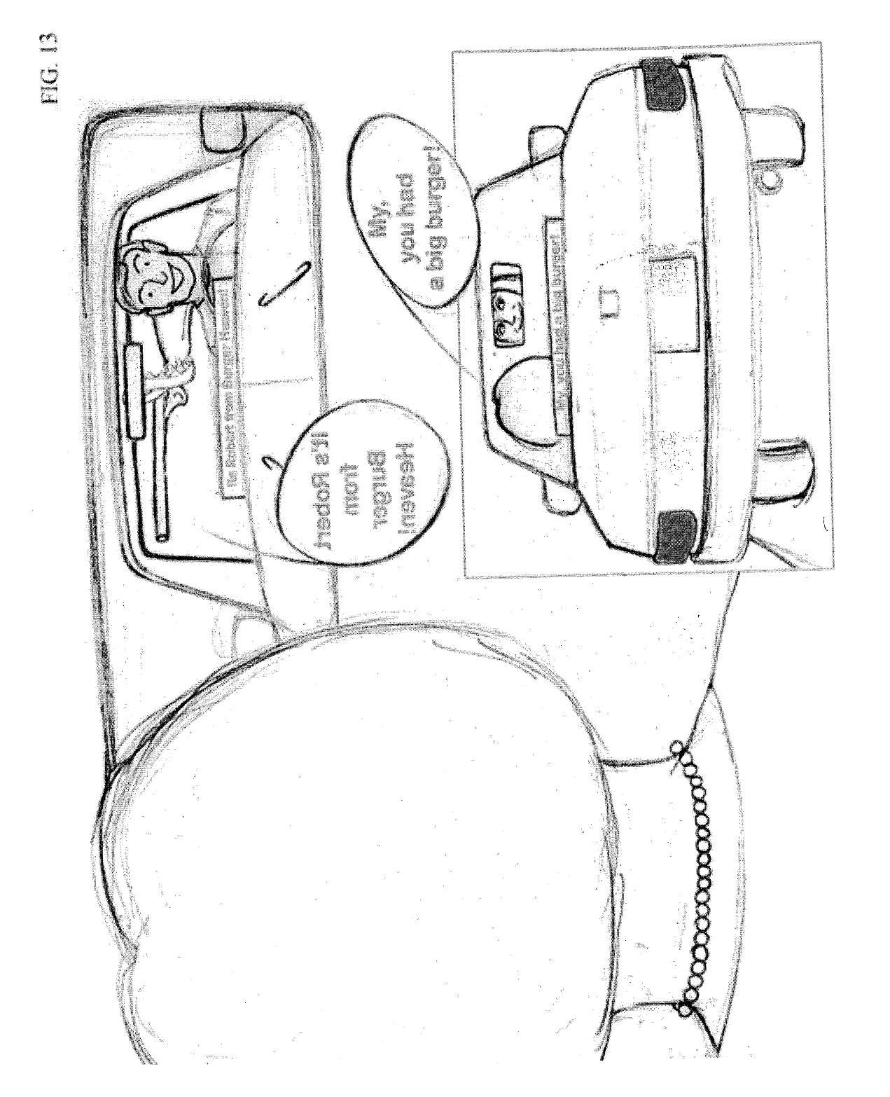

FIG. 13 illustrates the “mirror” feature of the invention. Here, a male driver sees a female driver in the car in front on a highway, whom he recognizes. The male driver has sent a message saying “It's Robert from Burger Heaven.” The message is displayed on a display of the invention mounted in the front windshield of his car, but the message is displayed in reversed or mirrored format, that is readable in a mirror. The female in the front car sees the message in her rear-view mirror, and responds with a reply displayed from her display mounted in her back window toward the rear in normal fashion. This is a significant safety feature of the invention, since the woman in the front vehicle does not need to turn her head around to read the message sent from the vehicle behind her.

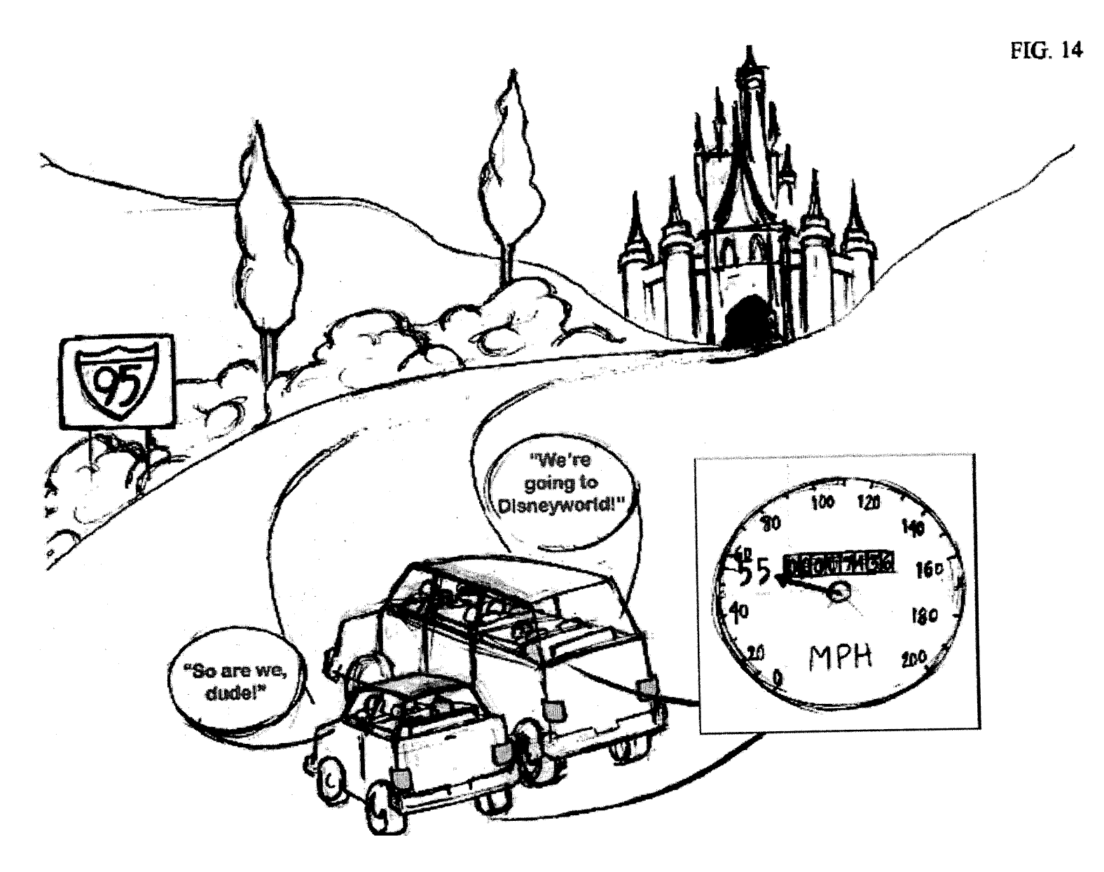

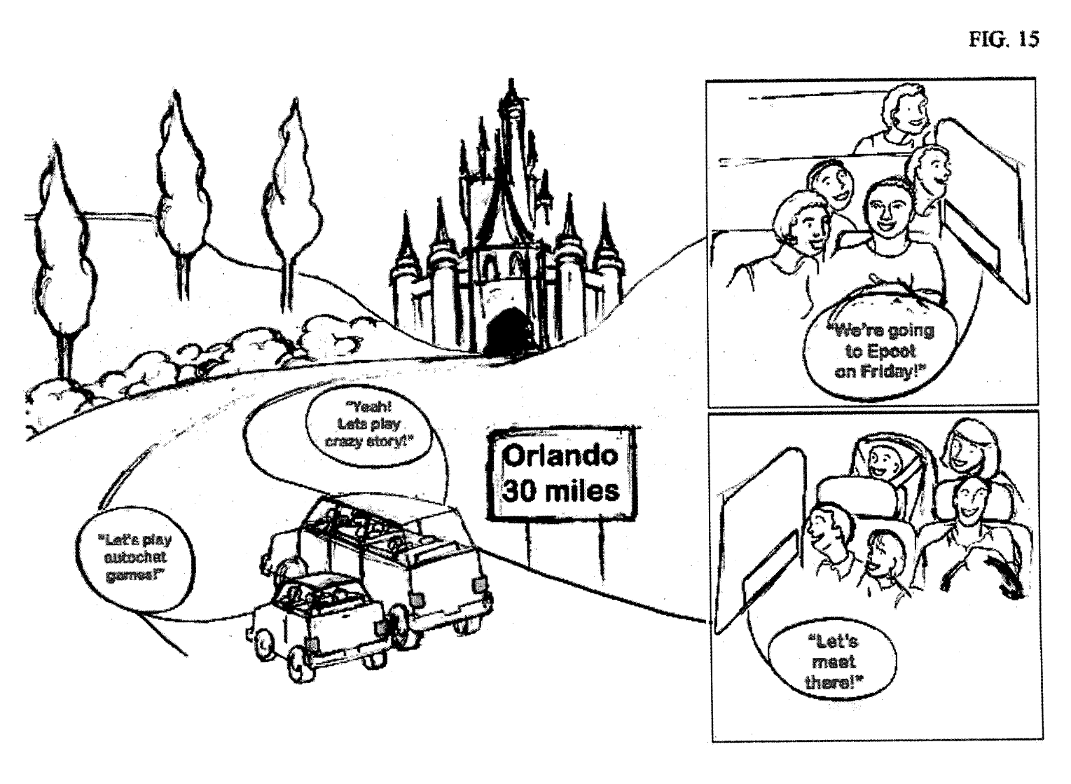

FIGS. 14-19 are artistic renditions showing use of the invention in various other situations and contexts to enable spontaneous, instant, context-driven, two-way visual messaging between vehicles, and, more particularly, between and among individuals each with a device. In FIGS. 14-15, two groups of families or friends are shown traveling together in separate vehicles on a highway. One passenger has displayed “We're going to Disney world.” A nearby passenger has responded “So are we, dude!” In FIG. 15, as the two groups get closer to their destination, one passenger chats “We're going to Epeot on Friday!” A nearby passenger then responds “Let's meet there!” In FIG. 15, one child in one vehicle suggests to a child in an adjacent vehicle that they play an interactive game using the invention.

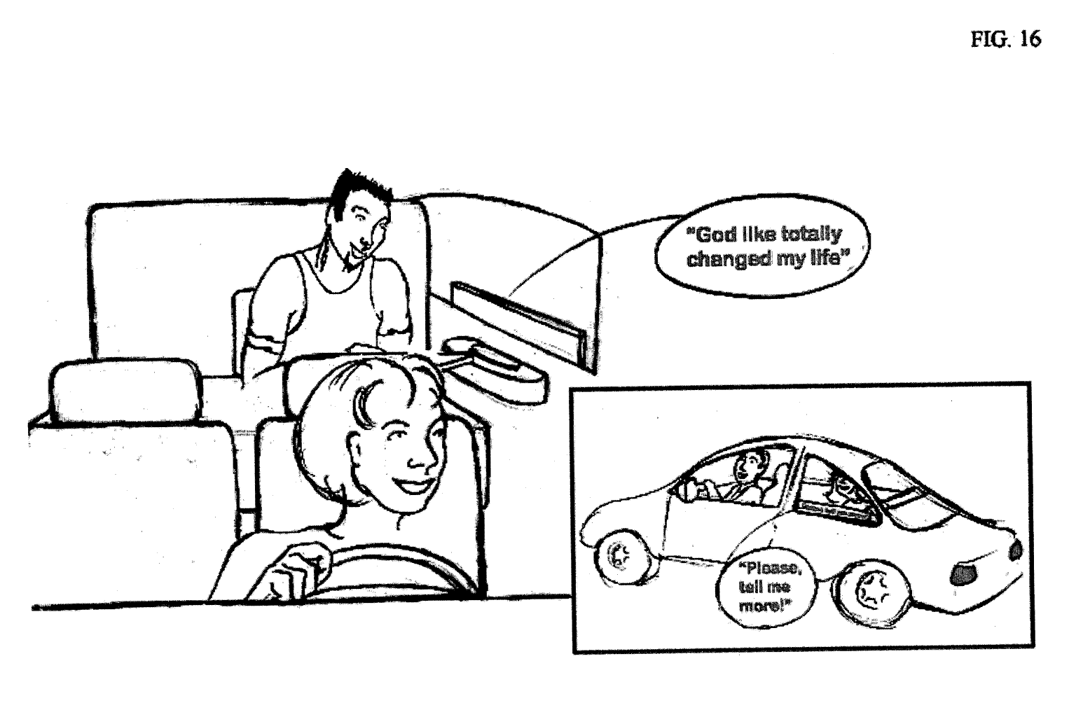

In FIG. 16, a passenger has displayed “God like totally changed my life”, and a passenger in a nearby vehicle has responded “Please tell me more!”

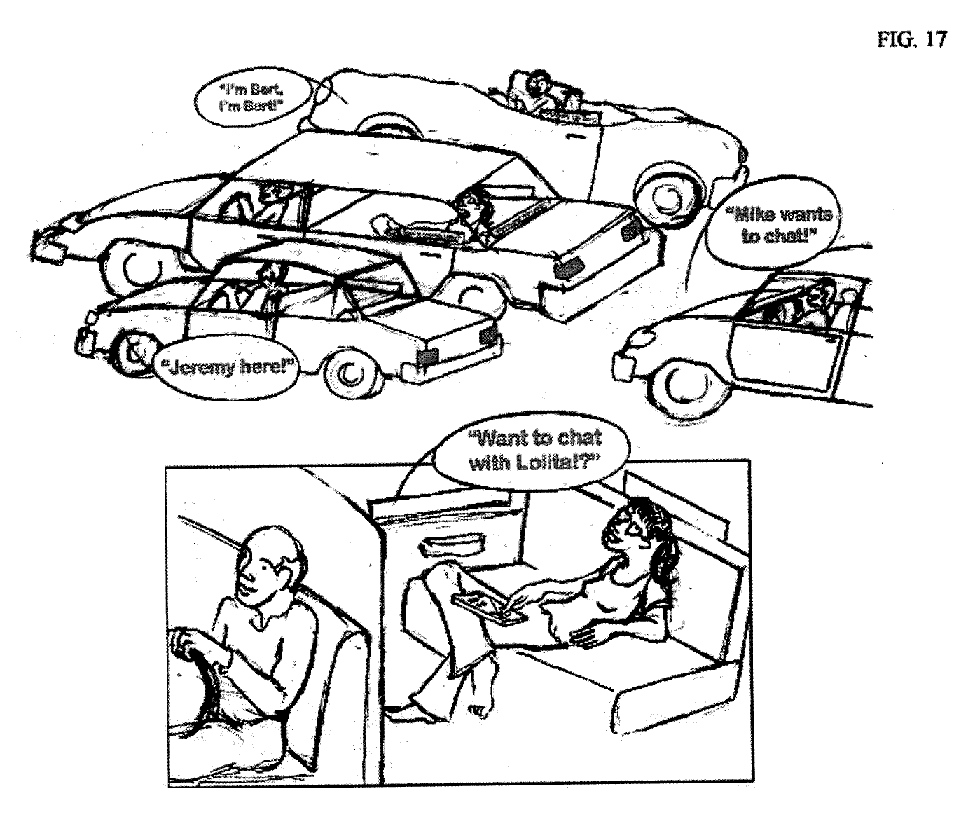

FIG. 17 illustrates that multiple groups of vehicles can engage in spontaneous chat sessions simultaneously. For example, an attractive, apparently wealthy, woman passenger in a limousine says “Want to chat with Lolita?” The message is displayed on all displays mounted in her vehicle. Instantly, three men in nearby vehicles respond with their names and return invitations to chat.

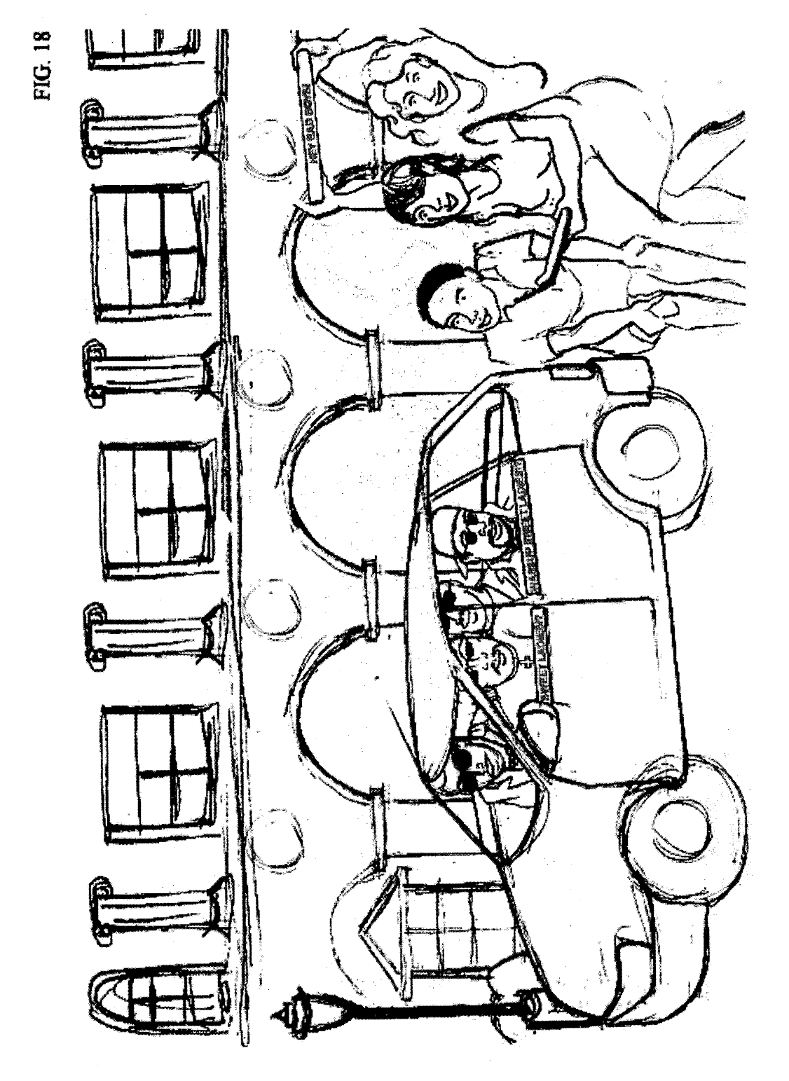

FIG. 18 illustrates that the invention may be used not only to communicate between vehicles, but also from vehicles to engage nearby pedestrians, vendors, etc., perhaps also equipped with a device, in conversation.

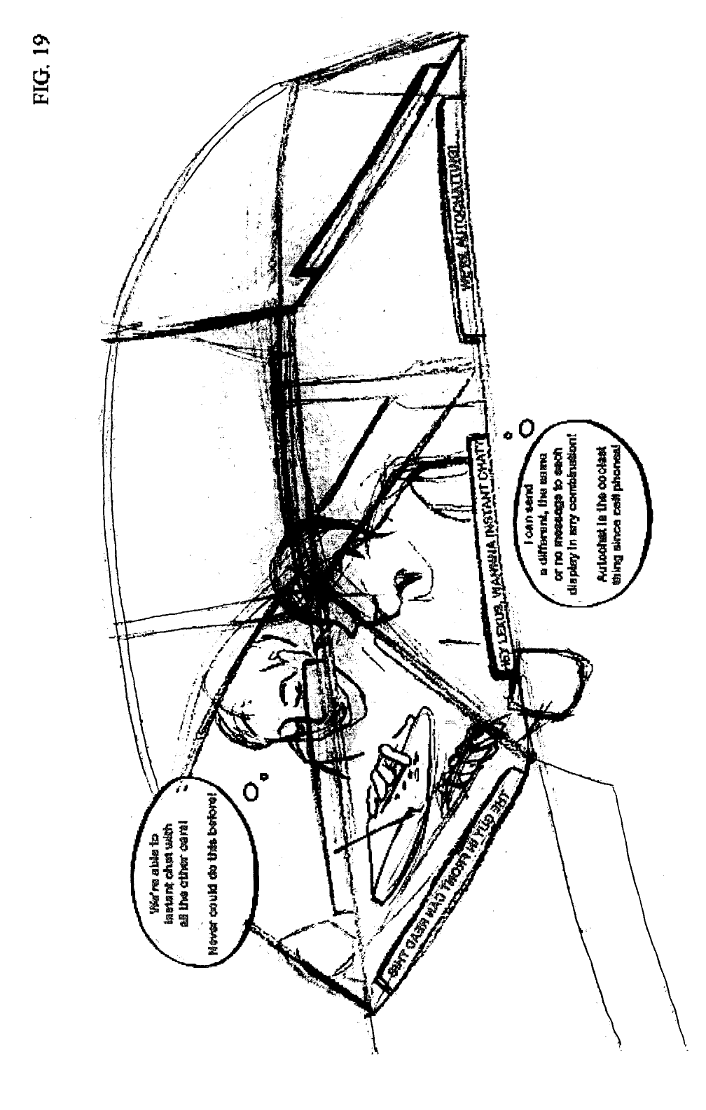

FIG. 19 illustrates the “mirror text” feature of the invention again. In this drawing, a display is mounted in the front windshield. The passenger in the right front seat is typing a message, displayed in mirrored format, readable to a passenger in a vehicle in front. Other displays with messages displayed in normal fashion are also shown.

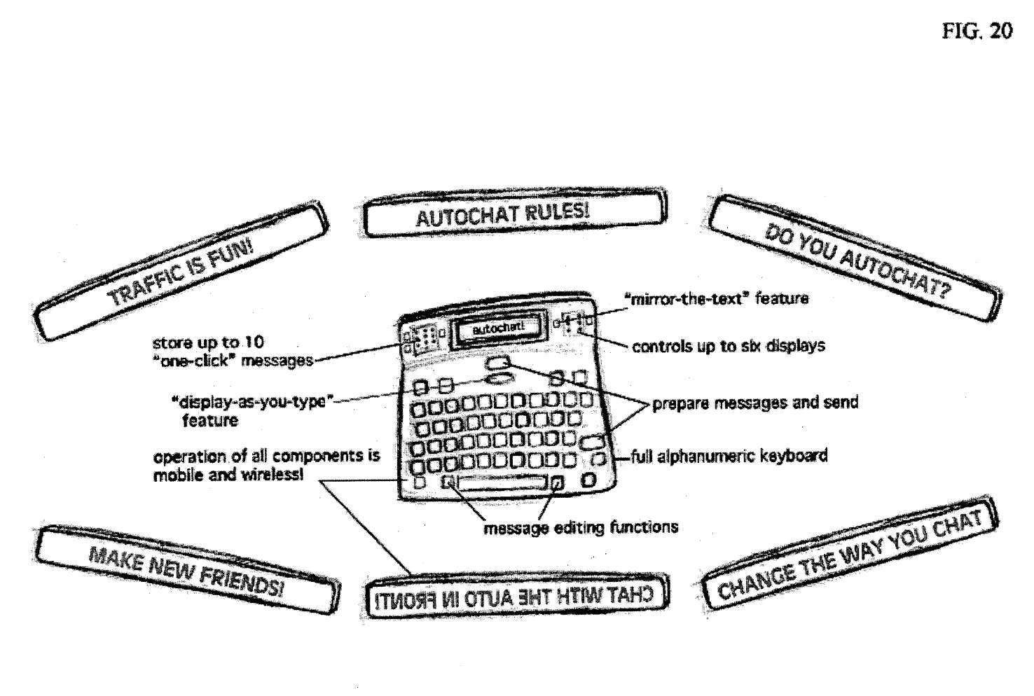

FIG. 20 is a pictorial diagram illustrating yet another view of the entire system of one embodiment of the present invention, namely one command terminal communicating wirelessly with six separate displays, each display showing a different message simultaneously, some or all of which may be either displayed normally or in reversed format.

All displays, regardless of their assigned address location on the command terminal, can receive “mirrored” text to further enable the mobile nature of the device.

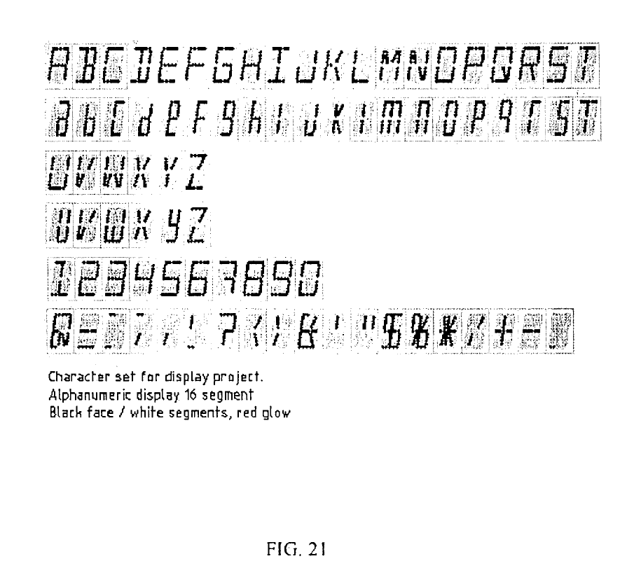

FIG. 21 is an alphanumeric display character set for one embodiment of the invention.

Command Terminal Circuit Operation

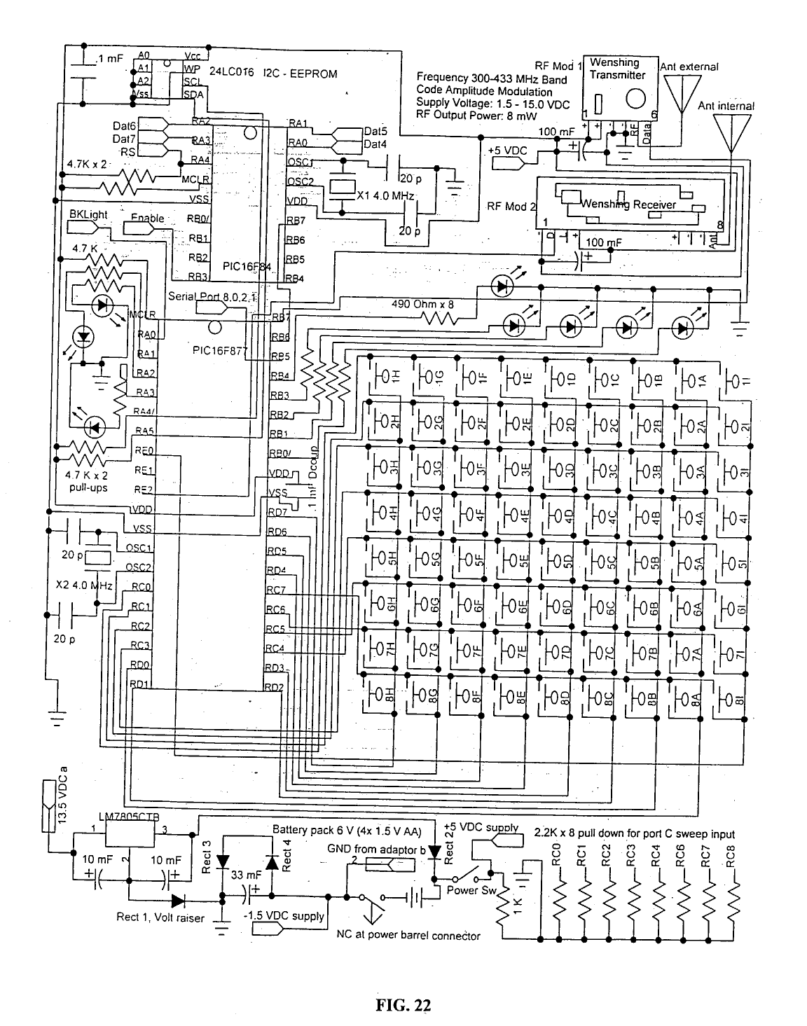

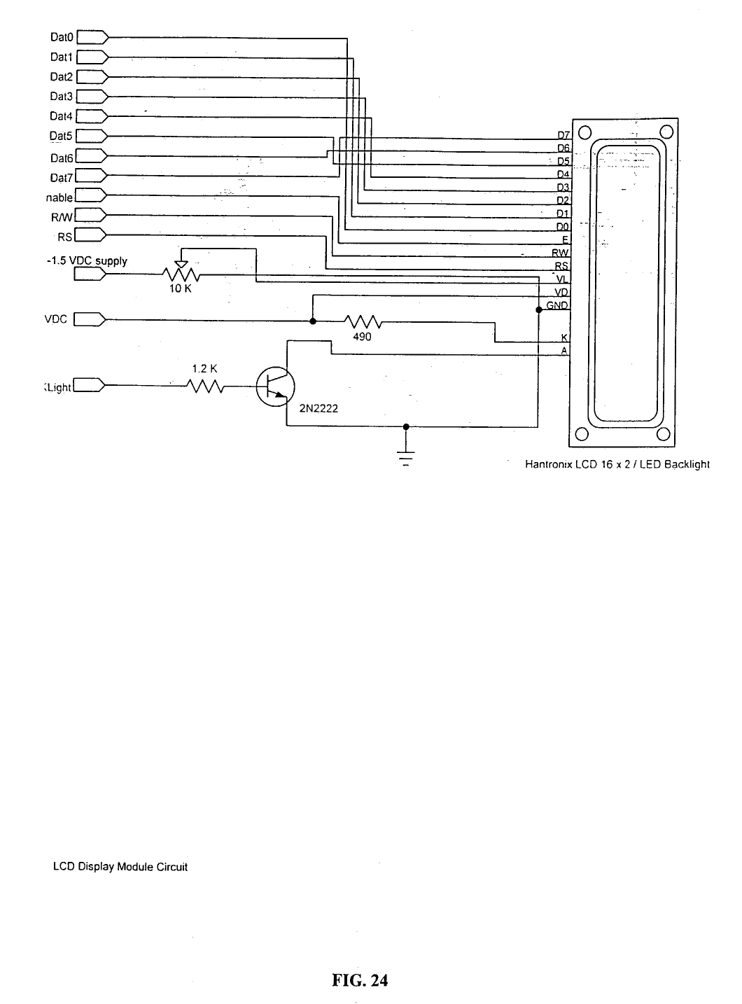

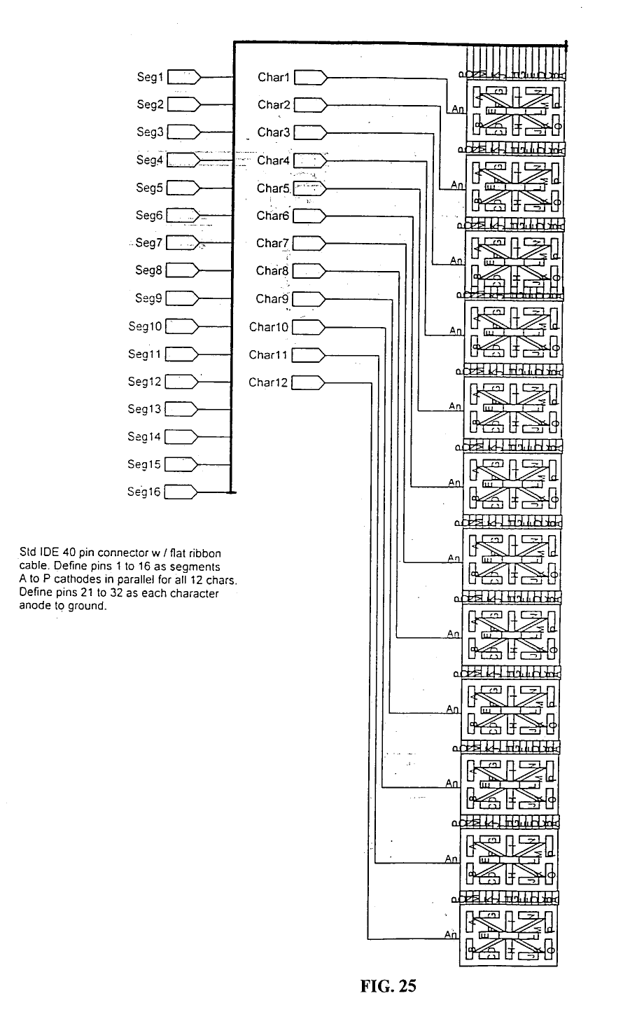

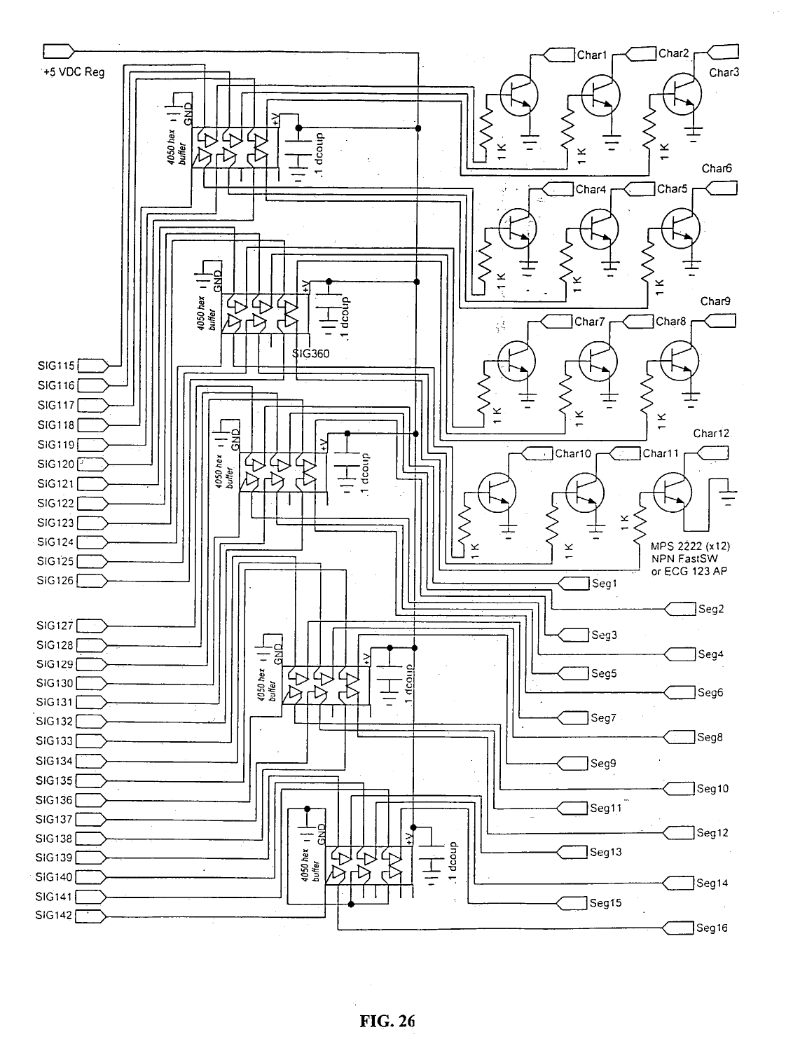

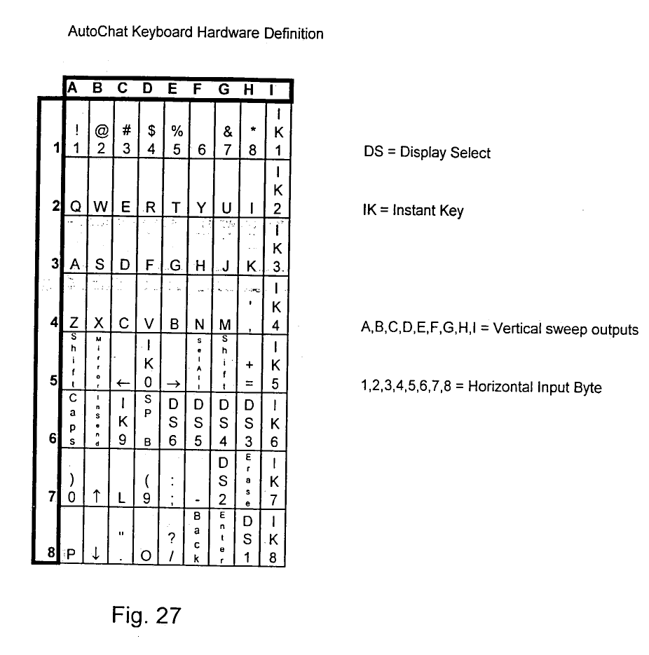

FIGS. 22-26 show electrical schematic diagrams of the control terminal and a display of one preferred embodiment of the invention. It is to be understood, of course, that the present invention is not limited to the specific component brands, model types, or numerical component values shown and described in this description or in the figures.

In a preferred embodiment, the command terminal uses a “master” and “slave” microcontroller or microprocessor, running under the control of a software or firmware “operating system”. The command terminal also includes a full alphanumeric keyboard, one or more memory devices, such as EEPROMS, other function keys as described previously, a radio transmitter and receiver, and other devices. Most, if not all, of the individual components shown in the drawings 22-26 are commercially available. However, the specific combination described herein is unique.

In one embodiment, the master microcontroller may comprise the PIC16F877 Microcontroller made by Microchip Inc.

At the first stage, the power from a car or other vehicle battery or the unit's battery pack is regulated at 5 VDC; prior to that two rectifier diodes are used to isolate the power supplies from each other, and then the power switch is located in series just before the regulator itself. The regulator uses a 100 mF capacitor at the input to filter any noise from the car's alternator and a 0.1 mF capacitor at the output to eliminate any remaining ripples. All the active components through the circuit use a 0.1 mF capacitor across the power pins to decouple or de-spike the device and eliminate voltage fluctuations.

The PIC16F877 microcontroller is driven by a 4 MHz crystal that is referenced to the ground via two 20 pF ceramic capacitors.

The master microcontroller has five ports (RA, RB, RC, RD and RE); Port B has direct memory allocation for each bit, port C is dedicated exclusively for the reading of the keyboard. This MCU uses particular memory allocations for the control and reading of analog devices so it limits some ports for not using the 8 bits that the full byte can give, RA has 6 bits available for the user and RE has 3.

The microcontroller PIC16F84 is used as a slave MCU and is also driven by a 4 MHz crystal with the 20 pF capacitors. The outputs for the indicators use 490 ohm resistors, for example, on each of them to limit the current for the LEDs.

The RF transmitting module, in this embodiment, is a Wenshing 900 series transmitter on a board with very compact design; it can give 8 mW of power, enough to cover 6 feet as a minimum. The frequency of transmission forces the antenna length of 30 cm to keep power return loss at minimum and maximize the efficiency of the RF amplifier stages. The module requires a bigger decoupling capacitor (100 mF) to better eliminate noise in the power line.

The command terminal also uses a Wenshing 900 receiver module to verify, before transmitting any characters, that the frequency is clear from interference. If another transmitter is in use, the device enters in a continuous loop to check the frequency every 8 milliseconds, until the frequency is cleared and the device resumes its normal operation.

In one embodiment, both the master and slave microcontrollers require that the reset pin (MCLR) to be pulled up to VCC by a 4700-ohm resistor, to allow internal reset and preventing an unwanted in-use reset.

The memory chip uses a default address, so the connection configuration for the pins /A0, A1 and A2 will be 0,0,0 and is the same to be assigned to the chip by the firmware.

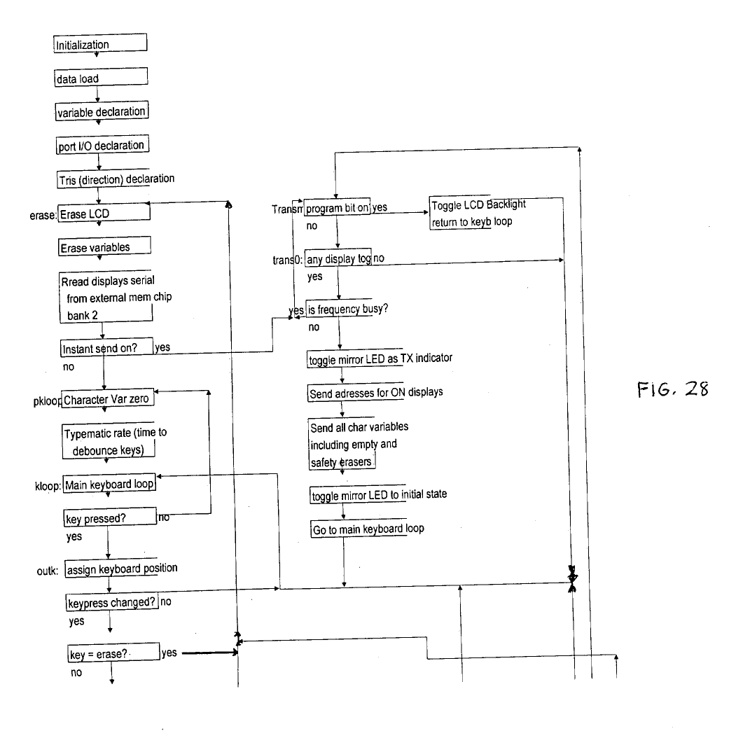

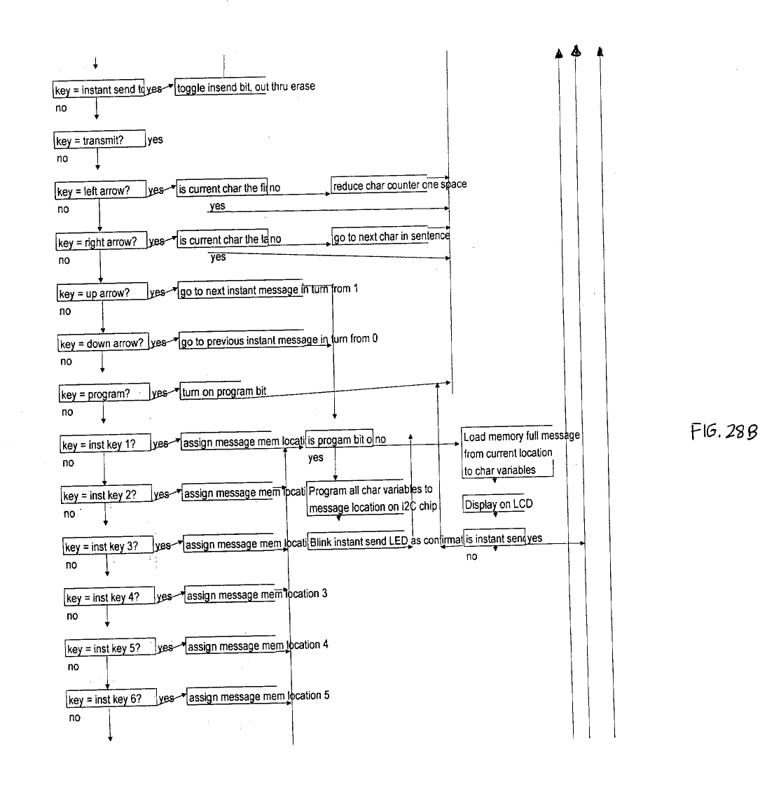

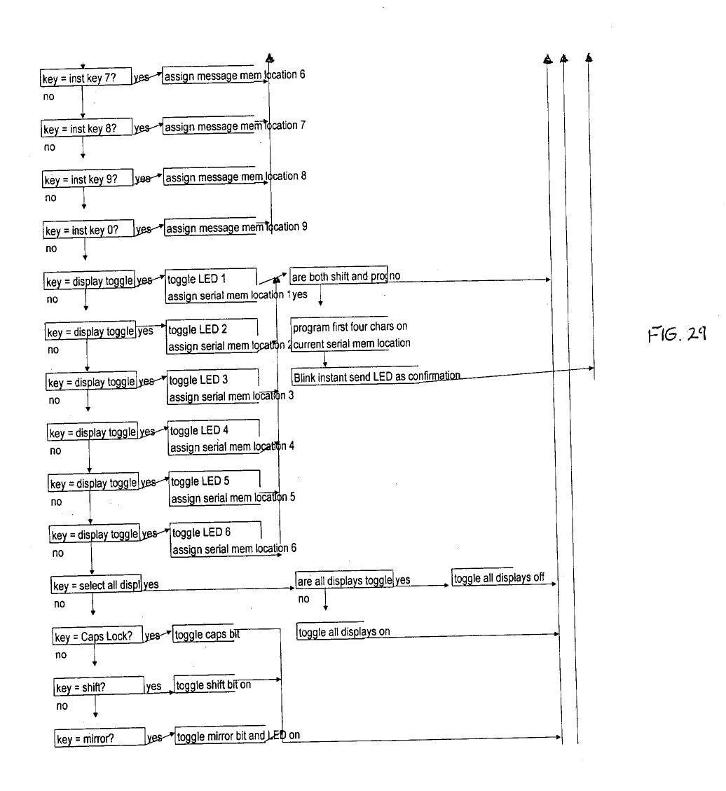

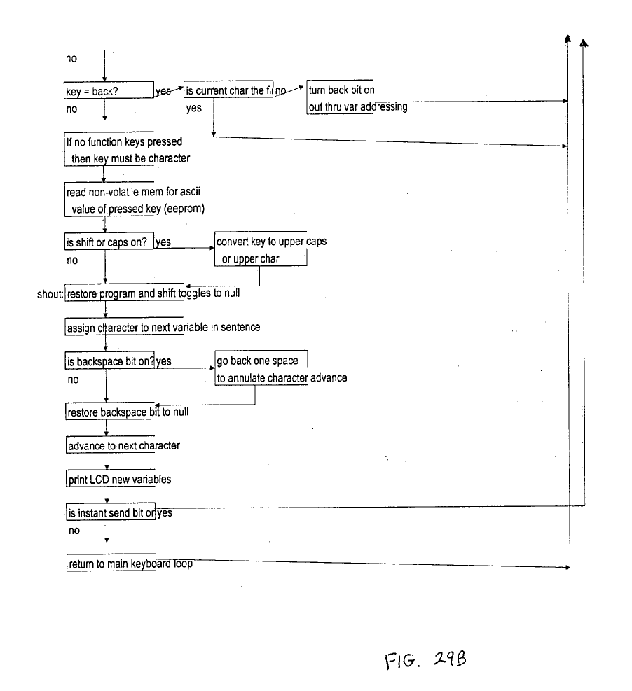

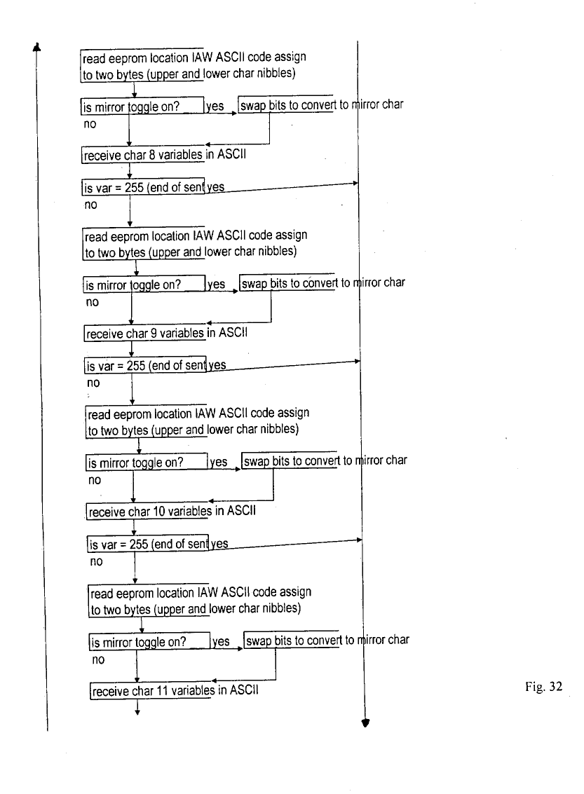

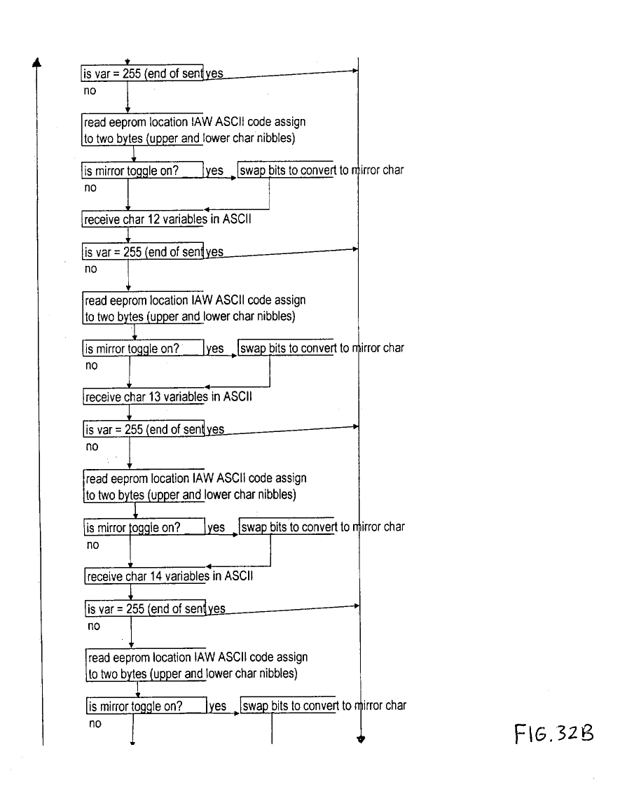

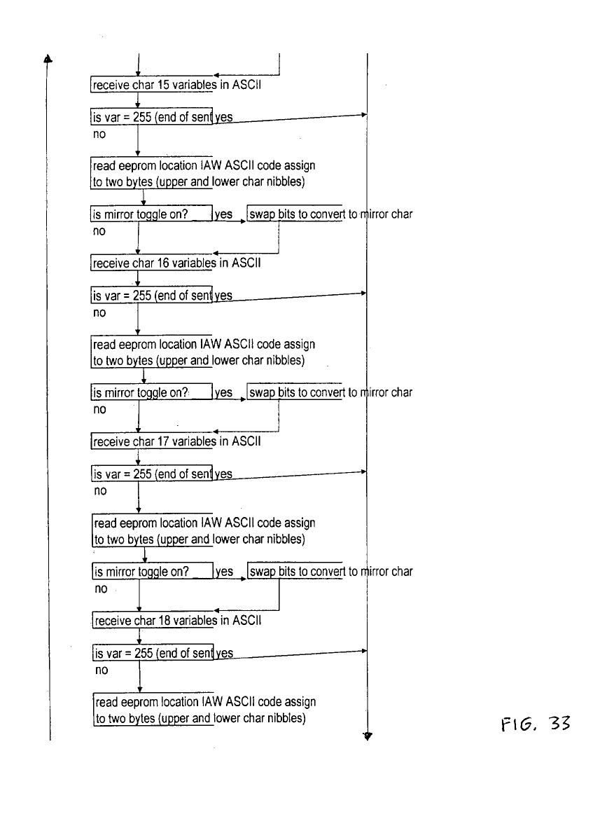

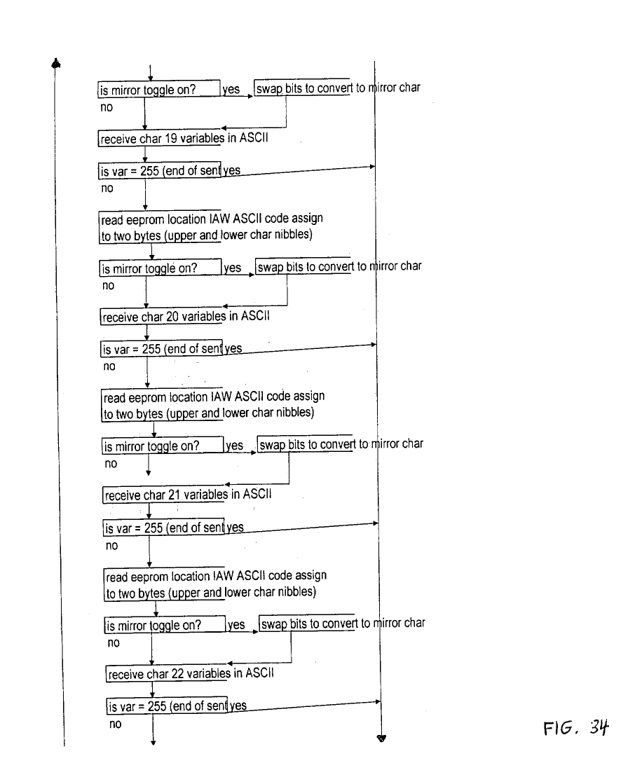

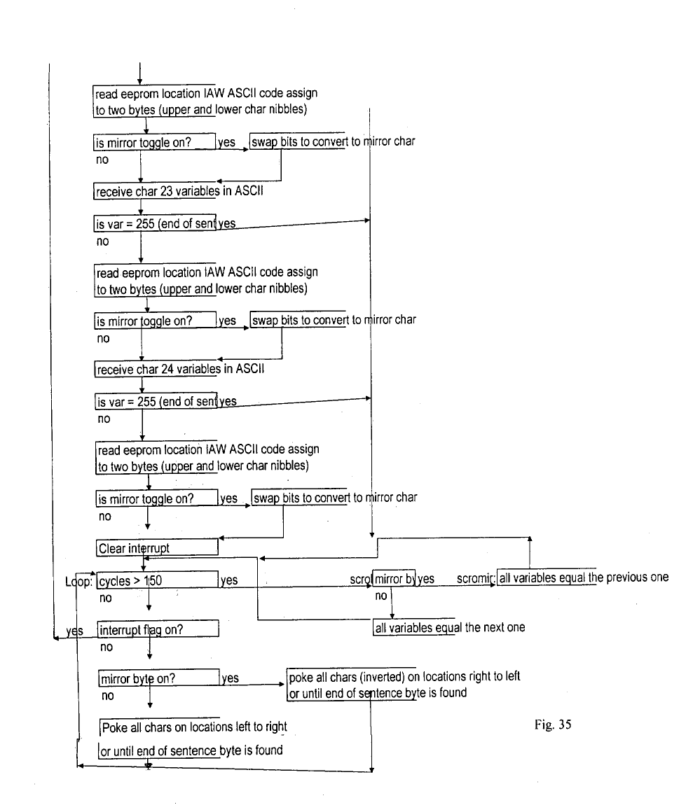

The main firmware subroutines run as shown in FIGS. 28-36.

Keyboard output assignation (outputs A to I) using 9 pins in the order RD7, RD6, RD5, . . . , RD0 and RB5.

Byte read as complete port C (RC0 to RC7), where the value of port C should always be 0 (because the pull down resistors) unless a key is pressed, in that case the loop will be stopped and a character definition will be retrieved from the def-tables and assigned to a variable.

If the key is a command key, the command is executed and the program control goes to the data retrieving routines, the data send routines or goes back to the main keyboard reading loop to let the user input more characters.

The characters are defined as a two-byte interpretation of the 16 segment display, where each bit represents a lit segment.

Memory Read/Write

The i2c memory chips 24LC256 are used in conjunction with the PIC Microcontrollers because the direct compatibility, fast connections, simplicity of functions, fair capacity and price. The read write routines require two simple commands to operate and the storage characteristics are exactly the desired ones. The memory data stored in these chips doesn't require any external power and can be kept for 100 years without danger of corrupting.

Indicator Activation

When a command that requires an indicator light to be manipulated, the appropriate signal is transmitted to the slave Microcontroller thru output RB6 and the slave MCU turns on the appropriate LED.

Character Display

At each stoke and with each command, different screens have to be activated and changed by sending the appropriate data to the LCD module using RB0 to RB3 and RA0 to RA3 and the reset, enable and Read/Write modes using ports RE0, RE1 and RE2.

Transmit Characters

Once the appropriate values for the character strings have been assigned, the slave MCU sends the acknowledge bits interlaced with the data, so the display or the group of active displays recognizes the transmission as local and validates it.

At power up, the CT will acknowledge if an external source is connected to the expansion port and will verify the appropriate RS232 levels. If a device answers the call, the main keyboard scanning loop is skipped and the MCU will run a serial reading routine instead. Also at the startup, a full clear command will be sent to the displays.

Display Circuit Operation

Similarly to the command terminal, the display unit, in one embodiment, also uses the two PIC Microcontrollers as the main components with a couple of major differences:

The master chip is now the PIC16F84 and the slave is the PIC16F877.

The unit does not need the external memory chips, because once the transmitted data is received, only the address is decoded and then compared to the electronic address from the micro-switches; if it matches, the posting loop is stopped and the new data stream is released to the slave MCU.

At the first stage, the power from the car battery or the unit's battery pack is regulated at 5 VDC, prior to that two rectifier diodes are used to isolate the power supplies from each other, and then the power switch is located in series just before the regulator itself. The regulator uses a 100 mF capacitor at the input to filter any noise from the car's alternator and a 0.1 mF capacitor at the output to eliminate any remaining ripples. All the active components through the circuit use a 0.1 mF capacitor across the power pins to decouple or de-spike the device and eliminate voltage fluctuations.

The PIC16F84 is driven by a 4 MHz crystal that is referenced to the ground via two 20 pF ceramic capacitors.

The PIC16F877 microcontroller is used as a slave MCU and is also driven by a 4 MHz crystal with the 20 pF capacitors. The outputs are buffered using a stage of the 4050 non-inverting Hex Buffer.

The RF receiving module is, in this embodiment, a Wenshing 900 series receiver. The frequency of transmission forces the antenna length of 30 cm but the unit works fine if part of the length is hidden inside the plastic case. The module may require a decoupling capacitor of 10 mF to eliminate noise in the power line.

Both microcontrollers require that the reset pin (MCLR) to be pulled up to VCC by a 4700 ohm resistor, to allow internal reset and preventing an unwanted in-use reset.

Once the MCU's outputs have been buffered, 16 of them are used to power the segment's cathodes and 12 are used to polarize the base of their correspondent power transistor to feed ground signal to each character in sequence. This sweep action takes place around 50 times per second, so the display operation relies on the persistence of vision effect to present the characters to the reader. The minimum of frames per second that any device can display so the human eye doesn't catch a strobe effect is 30.

The signal is fed to each power transistor (High speed switching MPS 2222 or equivalent) thru a current limiting resistor of 1000 ohms

The display character is then formed or “printed” by forming chains of LEDs numbering 48 per character that shape all the possible combinations of forms to produce a full character set. In an alternative embodiment, the display character could be formed in a “double-eight-like” configuration, under bar formed diffuser lenses, forming all the possible combinations of forms to produce a full character set with one or more LED(s) illuminating each bar.

Some of the firmware subroutines run as follows:

A string is received by the RF module and fed to the master MCU by pin RB4

The address is decoded from the string and compared to the address switches connected on pins RA0 to RA3. Each one of these inputs has a pull up resistor of 10000 ohms so if a switch is open, the leg won't float.

If the address matches to the decoded one, input RB4 on the slave chip is changed of state and the plotting loop is interrupted. Then the double byte is transmitted to the slave chip using input RB3.

The slave chip receives the characters one by one until it reaches the 24^{th} or when the end character is passed, then the remaining variables are zeroed and the display loop begins.

If the number of characters exceeds 12, then the display shows the first twelve for four seconds and then starts scrolling all the remaining characters. Once it reaches the end of the string, it displays three empty spaces and then starts over indefinitely or until a new string is received and decoded.

Flowcharts

FIGS. 28 and 29, taken together, set forth a flowchart representation of the primary operations carried out within the command terminal of FIG. 1, controlled primarily by the master microcontroller of FIG. 22.

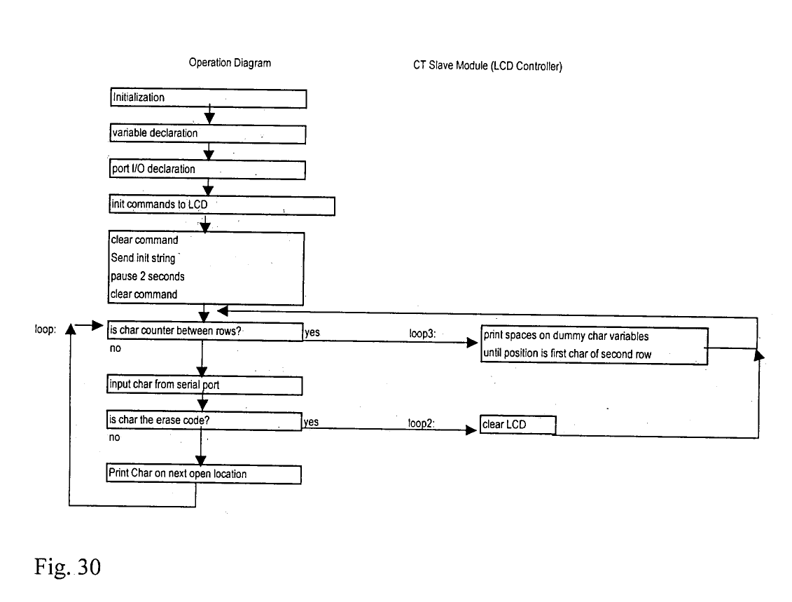

FIG. 30 sets forth a flowchart representation of command terminal operations carried out primarily by the slave microcontroller of FIG. 22.

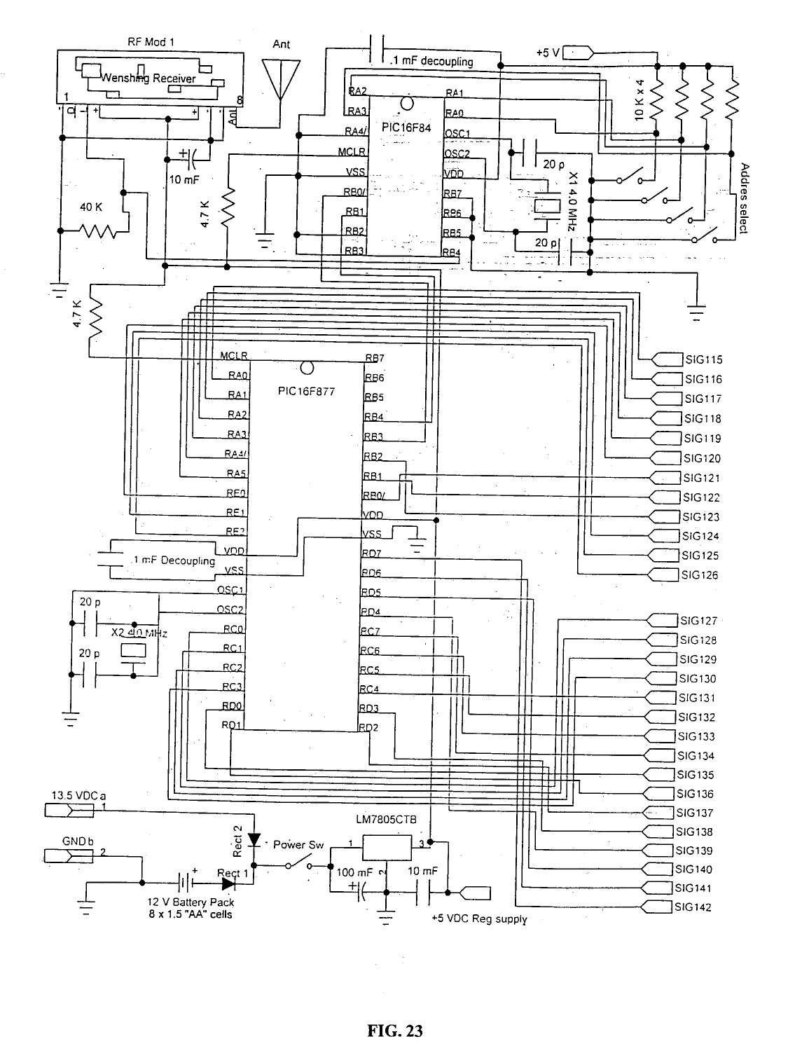

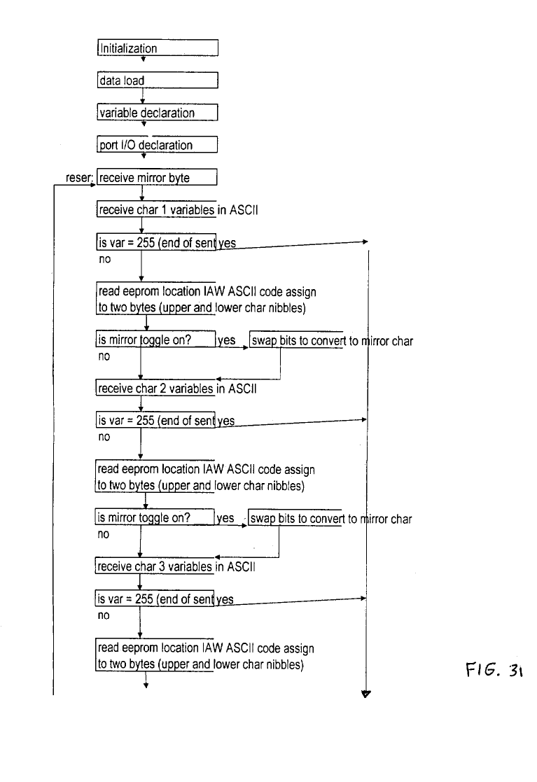

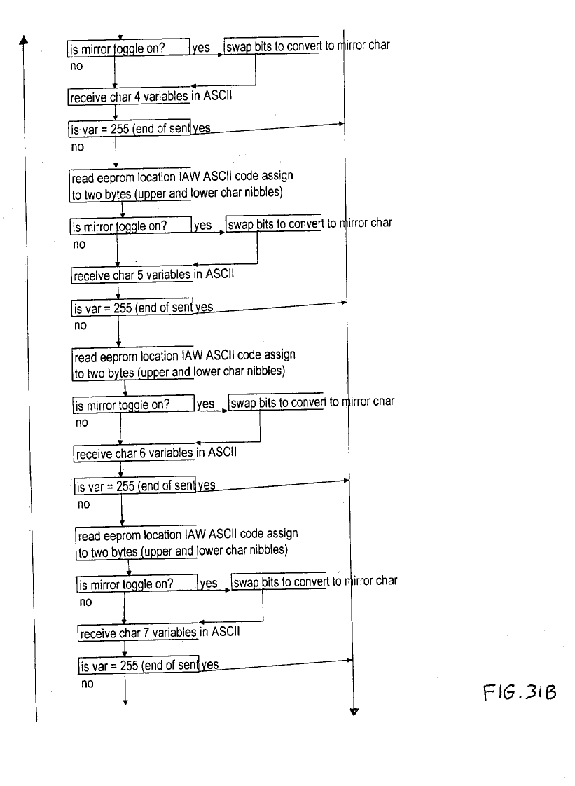

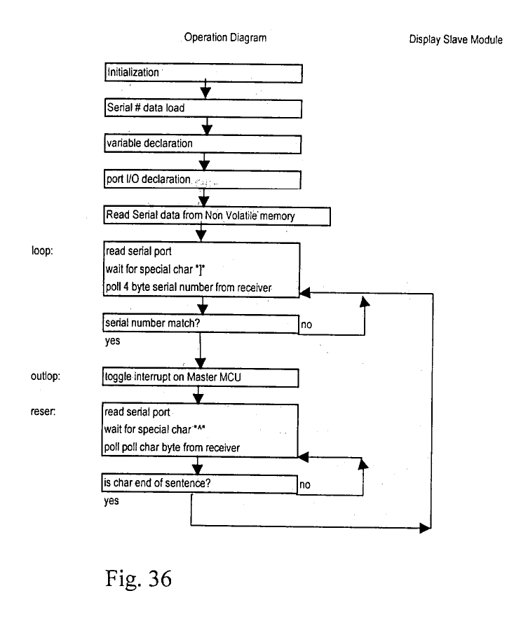

FIGS. 31-35, taken together, set forth a flowchart representation of the primary operations carried out with the display of FIG. 4, controlled primarily by the slave microcontroller of FIG. 23. FIG. 36 sets forth a flowchart representation of display operations carried out primarily by the slave microcontroller of FIG. 23.

What is claimed is:

1. A two-way, reciprocal, instant visual messaging system comprising a mobile electronic command terminal and at least one mobile, external, electronic display in communication with the command terminal, the command terminal configured to enable the creation and sending of variable messages to the display(s), where the command terminal and display(s) do not require a shared network with other command terminals or their associated display(s) to communicate.

2. The system of claim 1, in which either the command terminal or the display(s), or both, are battery-powered.

3. The system of claim 1, in which the command terminal communicates with the display(s) wirelessly.

4. The system of claim 1, in which the command terminal includes at least one programmable facility for recalling and sending stored message(s).

5. The system of claim 1, in which any display is interchangeable with any other display until a particular display is logically assigned to a particular command terminal and a particular address by a user relative to that particular command terminal, which logical assignment may be released or changed at a user's option.

6. The system of claim 1, in which the command terminal is configured to communicate with at least six different, selectable displays simultaneously, at a user's option.

7. The system of claim 1, in which the command terminal is configured to enable each of its associated display(s) to display either the same message, different messages, or no message simultaneously, in any combination, at a user's option.

8. The system of claim 1, in which the command terminal includes an input facility to enable a user to create messages in any language or visual form.

9. The system of claim 1, in which messages are created from a voice input.

10. The system of claim 1, in which the command terminal includes a built-in screen suitable for displaying message units as they are generated or recalled from a memory, and further includes facilities to enable the creation, storing and editing of messages prior to being sent to the display(s).

11. The system of claim 1, in which the command terminal is configured instantly to send, at a user's option, a message unit to the display(s) immediately as the unit is inputted.

12. The system of claim 1, in which the command terminal is configured to store at a user's option, at least one complete message in at least one memory, for later sending to the display(s).

13. The system of claim 1, in which the command terminal is configured to store, at a user's option, a plurality of complete messages in a memory, each message being available for later recall and display by means of a programmable “one-step” facility.

14. The system of claim 1, in which the command terminal is configured to include an optional “mirror” feature that, when activated, causes messages to be displayed in reverse format on one or more selected display(s), such that the message may be read in normal fashion by viewing the message in a mirror.

15. The system of claim 1, in which the command terminal includes at least one memory and one or more microprocessors or microcontrollers operating under software control.

16. The system of claim 1, in which the display(s) include one or more microprocessors or microcontrollers operating under software control.

17. The system of claim 1, in which the command terminal includes a radio frequency transmitter and a radio frequency receiver to monitor the frequency of the transmission, and each display includes a radio frequency receiver, for enabling the command terminal to transmit message data to the display(s) assigned to the command terminal by radio signals so as to eliminate interference from other command terminals and other sources.

18. The system of claim 1, in which either or both the command terminal and the display(s) are removably attachable to a vehicle.

19. The system of claim 1, in which either or both the command terminal and the display(s) are permanently integratable with and installed within a vehicle.

20. The system of claim 1, in which either the command terminal or the display(s), or both, are powered through a vehicle's cigarette lighter.

21. The system of claim 1, in which either the command terminal, the display(s), or both, are powered through an AC power adapter.

22. A system for enabling live, instant, spontaneous, context-driven, interactive, mutual, reciprocal, dynamic, programmable, two-way, variable visual message communications among persons in different vehicles, comprising:
an electronic command terminal suitable for use by a person in a vehicle, the command terminal suitable for attachment to a vehicle, the command terminal configured to enable the creation, editing, storing and sending of variable messages, the command terminal further not requiring a shared network with other command terminals or their associated display(s) to communicate; and
at least one external electronic display in communication with the command terminal, the display(s) suitable for attachment to a vehicle and configured to receive messages sent via the command terminal and to display the messages to be visible by other potential visual messaging interlocutor(s).

23. The system of claim 22, in which either or both the command terminal and the display(s) are mobile.

24. The system of claim 22, in which either or both the command terminal and the display(s) are removably attachable to a vehicle.

25. The system of claim 22, in which either or both the command terminal and the display(s) are permanently integratable with and installed within a vehicle.

26. The system of claim 22, in which the command terminal communicates with the display(s) wirelessly.

27. The system of claim 22, in which the command terminal includes at least one programmable facility for recalling and sending stored message(s).

28. The system of claim 22, in which the command terminal is configured to communicate with at least six different, selectable displays simultaneously, at a user's option.

29. The system of claim 22, in which the command terminal is configured to enable each of its associated display(s) to display either the same message, different messages, or no message simultaneously, in any combination, at a user's option.

30. The system of claim 22, in which any display is interchangeable with any other display until a particular display is logically assigned to a particular command terminal and a particular address by a user relative to that particular command terminal, which logical assignment may be released or changed at the user's option.

31. The system of claim 22, in which the command terminal includes an input facility to enable a user to create messages in any language or visual form.

32. The system of claim 22, in which messages are created from a voice input.

33. The system of claim 22, in which the command terminal includes a built-in screen suitable for displaying message units as they are generated or recalled from a memory, and further includes facilities to enable the creation, storing and editing of messages prior to being sent to the display(s).

34. The system of claim 22, in which the command terminal is configured instantly to send, at a user's option, a message unit to the display(s) immediately as the unit is inputted.

35. The system of claim 22, in which the command terminal is configured to store at a user's option, at least one complete message in at least one memory, for later sending to the display(s).

36. The system of claim 22, in which the command terminal is configured to store, at a user's option, a plurality of complete messages in a memory, each message being available for later recall and display by means of a programmable “one-step” facility.

37. The system of claim 22, in which the command terminal is configured to include an optional “mirror” feature that, when activated, causes messages to be displayed in reverse format on one or more selected display(s), such that the message may be read in normal fashion by viewing the message in a mirror.

38. The system of claim 22, in which the command terminal includes at least one memory and one or more microprocessors or microcontrollers operating under software control.

39. The system of claim 22, in which the display(s) include one or more microprocessors or microcontrollers operating under software control.

40. The system of claim 22, in which the command terminal includes a radio frequency transmitter and a radio frequency receiver to monitor the frequency of the transmission, and each display includes a radio frequency receiver, for enabling the command terminal to transmit message data to the display(s) assigned to the command terminal by radio signals so as to eliminate interference from other command terminals and other sources.

41. The system of claim 22, in which either the command terminal or the display(s), or both, are battery-powered.

42. The system of claim 22, in which either the command terminal or the display(s), or both, are powered through a vehicle's cigarette lighter.

43. The system of claim 22, in which either the command terminal, the display(s), or both, are powered through an AC power adapter.

44. A method for two-way, reciprocal, instant visual messaging, comprising:
(a) providing a first mobile electronic command terminal to a first person and at least one first mobile electronic visual display in communication with the first command terminal;
(b) providing a second mobile electronic command terminal to a second person and at least one second mobile electronic visual display in communication with the second command terminal;
(c) creating a first message on the first command terminal and instantly, at the user's option, sending the first message to the first display(s), the first display(s) arranged to be visible by the second person; and
(d) creating a second message on the second command terminal in response to the first message and instantly, at the user's option, sending the second message to the second display(s), the second display(s) arranged to be visible by the first person.

45. The method of claim 44, in which the step(s) of sending the first message to the first display(s), or sending the second message to the second display(s), or both, are performed wirelessly.

46. The method of claim 44, in which the steps of sending messages between the first person and the second person are possible without the first command terminal and the first display(s) and the second command terminals and the second display(s) being part of a shared network.

47. The method of claim 44, in which the step(s) of creating the first message, or the second message, or both, are performed using at least one programmable facility at the first command terminal, the second command terminal, or both, respectively.

48. The method of claim 44, in which the first person designates the first command terminal to communicate with at least one of the first display(s) which are selectable, either by selecting one display at a time, by selecting some variable group that numbers less than the total number displays at once, or by selecting them all at once.

49. The method of claim 44, in which the second person designates the second command terminal to communicate with at least one of the first display(s) which are selectable, either by selecting one display at a time, by selecting some variable group that numbers less than the total number displays at once, or by selecting them all at once.

50. The method of claim 44, in which the first person, the second person, or both designates each display(s) associated with their respective command terminal(s) simultaneously to display, at said person's option, either the same message, a different message, or no message, in any combination.

51. The method of claim 44, in which the first person, the second person, or both, logically assign(s) a particular display, otherwise interchangeable, to their respective particular command terminal(s) and a particular address relative to that particular command terminal, and further in which said person may release or change said logical assignment at said person's option.

52. The method of claim 44, in which the first person, the second person, or both, employs an input facility at their respective command terminal(s) to create messages in any language or visual form.

53. The method of claim 44, in which either the first message, the second message, or both, are created with a voice input.

54. The method of claim 44, in which the first person, the second person, or both, employ(s) a built-in screen at their respective command terminal(s) to display message units as they are generated or recalled from a memory, and further may employ said screen to enable the creation, storing and editing of messages prior to sending them to the display(s) associated with said command terminal(s).

55. The method of claim 44, in which the first person, the second person, or both, programs their respective command terminal instantly to send, at said person's option, a message unit to display(s) associated with said command terminal(s) immediately as the unit is inputted.

56. The method of claim 44, in which the first person, the second person, or both may store at least one complete message in at least one memory at their respective command terminal(s), for later sending to the display(s) associated with said command terminal(s).

57. The method of claim 44, in which the first person, the second person, or both, program(s) their respective command terminal(s) to store, at said person's option, a plurality of complete messages in a memory, each message being available for later recall and sending to the displays associated with said command terminal(s) by means of a programmable “one-step” facility.

58. The method of claim 44, in which the first person, the second person, or both, designates their respective command terminal(s) to display message(s) created via said command terminal(s) in a reversed/mirrored format.

59. The method of claim 44, in which the operating of either the first command terminal, the second command terminal, or both is enabled by at least one memory and one or more microprocessors or microcontrollers operating under software control.

60. The method of claim 44, in which operating of either the first display(s), the second display(s), or both, is enabled by one or more microprocessors or microcontrollers operating under software control.

61. The method of claim 44, in which the first command terminal, the second command terminal, or both, include(s) a radio frequency transmitter and a radio frequency receiver which monitors the frequency of the transmission relative to said command terminal, and each display associated with said command terminal includes a radio frequency receiver, for enabling said command terminal to transmit message data to the display(s) assigned to the said command terminal by radio signals so as to eliminate interference from other command terminals and other sources.

62. The method of claim 44, in which power for either the first command terminal or the second command terminal, or the first display(s) or second display(s), or for some combination thereof, or for all, is provided by batteries.

63. The method of claim 44, in which the first person employs either or both the first command terminal and the first display(s) by removably attaching them to a vehicle.

64. The method of claim 44, in which the second person employs either or both the second command terminal and the second display(s) by removably attaching them to a vehicle.

65. The method of claim 44, in which the first person employs either or both the first command terminal and first display(s) by permanently integrating said components with and installing them within a vehicle.

66. The method of claim 44, in which the second person employs either or both the second command terminal and second display(s) by permanently integrating said components with and installing them within a vehicle.

67. The method of claim 44, in which power for either the first command terminal or the second command terminal, or the first display(s) or second display(s), or for some combination thereof, or for all, is provided by a vehicle's cigarette lighter.

68. The method of claim 44, in which power for either the first command terminal or the second command terminal, or the first display(s) or second display(s), or for some combination thereof, or for all, is provided by an AC power adapter.

69. A method for communicating live, instant, spontaneous, context-driven, interactive, mutual, reciprocal, dynamic, programmable, two-way, variable visual messages among persons in different vehicles, comprising:
(a) providing a first electronic command terminal and at least one first electronic display in the first vehicle, the first command terminal associated with and in communication with the first display(s);
(b) providing a second electronic command terminal and at least one second electronic display in the second vehicle, the second command terminal associated with and in communication with the second display(s);
(c) creating a first message on the first command terminal and instantly, at the user's option, sending the first message to the first display(s), the first display(s) configured to display the first message outside the first vehicle to be visible by the second vehicle;
(d) creating a second message on the second command terminal in response to the first message and instantly, at the user's option, sending the second message to the second display(s), the second display(s) configured visually to display the second message outside the second vehicle to be visible by the first vehicle.

70. The method of claim 69, in which either the first message, the second message, or both are created and sent where either the first command terminal and first display(s), the second command terminal and second display(s), or both, are mobile.

71. The method of claim 69, in which the first person employs either or both the first command terminal and the first display(s) by removably attaching them to a vehicle.

72. The method of claim 69, in which the second person employs either or both the second command terminal and the second display(s) by removably attaching them to a vehicle.

73. The method of claim 69, in which the first person employs either or both the first command terminal and first display(s) by permanently integrating said components with and installing them within a vehicle.

74. The method of claim 69, in which the second person employs either or both the second command terminal and second display(s) by permanently integrating said components with and installing them within a vehicle.

75. The method of claim 69, in which the step(s) of sending the first message to the first display(s), or sending the second message to the second display(s), or both, are performed wirelessly.

76. The method of claim 69, in which the steps of sending messages between the first person and the second person are possible without the first command terminal and the first display(s) and the second command terminals and the second display(s) being part of a shared network.

77. The method of claim 69, in which the step(s) of creating the first message, or the second message, or both, are performed using at least one programmable facility at the first command terminal, the second command terminal, or both, respectively.

78. The method of claim 69, in which the first person designates the first command terminal to communicate with at least one of the first display(s) which are selectable, either by selecting one display at a time, by selecting some variable group that numbers less than the total number displays at once, or by selecting them all at once.

79. The method of claim 69, in which the first person designates the first command terminal to communicate with at least one of the first display(s) which are selectable, either by selecting one display at a time, by selecting some variable group that numbers less than the total number displays at once, or by selecting them all at once.

80. The method of claim 69, in which the first person, the second person, or both designates each display(s) associated with their respective command terminal(s) simultaneously to display, at said person's option, either the same message, a different message, or no message, in any combination.

81. The method of claim 69, in which the first person, the second person, or both, logically assign(s) a particular display, otherwise interchangeable, to their respective particular command terminal(s) and a particular address relative to that particular command terminal, and further in which said person may release or change said logical assignment at said person's option.

82. The method of claim 69, in which the first person, the second person, or both, employs an input facility at their respective command terminal(s) to create messages in any language or visual form.

83. The method of claim 69, in which either the first message, the second message, or both, are created with a voice input.

84. The method of claim 69, in which the first person, the second person, or both, employs a built-in screen at their respective command terminal(s) to display message units as they are generated or recalled from a memory, and further may employ said screen to enable the creation, storing and editing of messages prior to sending them to the display(s) associated with said command terminal(s).

85. The method of claim 69, in which the first person, the second person, or both, programs their respective command terminal instantly to send, at said person's option, a message unit to display(s) associated with said command terminal(s) immediately as the unit is inputted.

86. The method of claim 69, in which the first person, the second person, or both may store at least one complete message in at least one memory at their respective command terminal(s), for later sending to the display(s) associated with said command terminal(s).

87. The method of claim 69, in which the first person, the second person, or both, program(s) their respective command terminal(s) to store, at said person's option, a plurality of coplete messages in memory, each message being available, for, later recall and sending to the displays associated with said command terminal(s) by means of a programmable “one-step” facility.

88. The method of claim 69, in which the first person, the second person, or both, designates their respective command terminal(s) to display message(s) created via said command terminal(s) in a reversed/mirrored format.

89. The method of claim 69, in which the operating of either the first command terminal, the second command terminal, or both is enabled by at least one memory and one or more microprocessors or microcontrollers operating under software control.

90. The method of claim 69, in which operating of either the first display(s), the second display(s), or both, is enabled by one or more microprocessors or microcontrollers operating under software control.

91. The method of claim 69, in which the first command terminal, the second command terminal, or both, include(s) a radio frequency transmitter and a radio frequency receiver which monitors the frequency of the transmission relative to said command terminal, and each display associated with said command terminal includes a radio frequency receiver, for enabling said command terminal to transmit message data to the display(s) assigned to the said command terminal by radio signals so as to eliminate interference from other command terminals and other sources.

92. The method of claim 69, in which power for either the first command terminal or the second command terminal, or the first display(s) or second display(s), or for some combination thereof, or for all, is provided by batteries.

93. The method of claim 69, in which power for either the first command terminal or the second command terminal, or the first display(s) or second display(s), or for some combination thereof, or for all, is provided by a vehicle's cigarette lighter.

94. The method of claim 69, in which power for either the first command terminal or the second command terminal, or the first display(s) or second display(s), or for some combination thereof, or for all, is provided by an AC power adapter.

95. A method for enabling a microprocessor-based, instant, visual message creation and display system, operating under software control, to perform the following steps:
(a) enabling a user to compose variable messages using an input facility to receive inputted message units via a command terminal;
(b) displaying the inputted message units on a screen at the command terminal as soon as each message unit is inputted;
(c) enabling the command terminal to send the inputted message units to one or more external display(s) at the user's option, after the user has composed a message, for external display of visible message units corresponding to the inputted message units;
(d) enabling the command terminal, at the user's option, instantly to send the inputted message units to the external display(s) as soon as each message unit is inputted;
(e) enabling the command terminal to store, at the user's option, one or more messages in at least one memory after the user has composed a message;
(f) enabling the command terminal to recall and send to the external display(s), at the user's option, one or more previously-stored messages using a programmable “onestep” facility;
(g) enabling the command terminal to send messages for display in a mirrored/reversed format, such that the message is readable in normal fashion by viewing it in a mirror;
(h) enabling the command terminal to control at least one individually selectable display(s), each display(s) able to be designated and non-designated to receive messages at a user's option;
(i) enabling the display(s) by means of the command terminal to display simultaneously the same, a different, or no message, on every display, in every combination, at a user's option; and
(j) enabling the user to edit messages via the command terminal.
